(19) United States
(12) Patent Application Publication
(10) Pub. No.: US 2026/0289147 A1
(43) Pub. Date: Sep. 24, 2026

(54) SYSTEM

(71) Applicant: SoftBank Group Corp., Tokyo (JP)

(72) Inventor: Yuichiro YAMAGUCHI, Tokyo (JP)

(73) Assignee: SoftBank Group Corp., Tokyo (JP)

(21) Appl. No.: 19/567,320

(22) Filed: Mar. 16, 2026

(30) Foreign Application Priority Data
Mar. 19, 2025 (JP) 2025-045111

(51) Int. Cl. G06F 40/35; G06N 3/0475; H04L 41/22

(52) U.S. Cl. CPC G06F 40/35; H04L 41/22; G06N 3/0475

(57) ABSTRACT

A system including a processor, wherein the processor is configured to acquire data from a user device via a communication network, analyze text data using natural language processing techniques and compare the analyzed text data with predefined abnormal patterns, and provide input data to a generative AI model and generate a prompt that instructs the generative AI model to describe details of an abnormal pattern and to encourage a user to take an appropriate action.

### CROSS-REFERENCE TO RELATED APPLICATION

This application is based on and claims priority under 35 USC 119 from Japanese Patent Application No. 2025-045111 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

In many environments where users communicate or input text through networked devices, abnormal patterns such as potentially harmful, inappropriate, or policy-violating text may appear in user communications or operational logs. Conventional systems that merely log such data or perform simple keyword filtering often fail to (i) accurately identify complex or context-dependent abnormal patterns, (ii) explain to the user why the detected pattern is considered abnormal, and (iii) guide the user toward an appropriate response or corrective action. As a result, users may overlook critical issues, misunderstand the reason for a warning, or be uncertain about how to respond when abnormal patterns occur. There is therefore a need for a system that can automatically acquire user data over a communication network, analyze text data to detect predefined abnormal patterns, and utilize a generative AI model to provide detailed, context-sensitive explanations and guidance, including real-time or user-configurable warning delivery.

### SUMMARY

In order to solve the above-described problems, according to one aspect of the present invention, there is provided a system comprising a processor, wherein the processor is configured to acquire data from a user device via a communication network, analyze text data using natural language processing techniques and compare the analyzed text data with predefined abnormal patterns, and provide input data to a generative AI model and generate a prompt that instructs the generative AI model to describe details of an abnormal pattern and to encourage a user to take an appropriate action. The processor may be further configured to transmit a warning message to the user in real time, so that the user can promptly recognize the abnormal pattern and respond without delay. The processor may also be configured to adjust a timing at which the user receives the warning message based on a setting of the user, thereby allowing the user to select, for example, immediate notification or batch notification at predetermined intervals, and to receive detailed, AI-generated explanations and recommended actions in a manner that best fits the user's workflow.

The term “system” refers to an arrangement of one or more hardware and/or software components that cooperate to perform functions described in the present specification and claims, and may include servers, user devices, networks, storage, and executable programs.

The term “processor” refers to any hardware and/or virtual processing unit capable of executing instructions, including a central processing unit (CPU), graphics processing unit (GPU), microcontroller, digital signal processor (DSP), or a combination thereof, and may also encompass a plurality of processors operating in a distributed or cloud environment.

The term “user device” refers to any terminal or client device operated by a user, including but not limited to a personal computer, smartphone, tablet, wearable device, or other computing device capable of sending and receiving data via a communication network.

The term “communication network” refers to any wired or wireless network, or a combination thereof, that enables data communication between the system and one or more user devices, and may include local area networks (LANs), wide area networks (WANs), cellular networks, the Internet, or private networks.

The term “data” refers to information obtained from a user device or other sources, including but not limited to text data, metadata, log data, message content, identifiers, timestamps, and any other information that may be processed by the system.

The term “text data” refers to data represented in a textual form, including but not limited to messages, emails, chat logs, documents, transcribed speech, and any other character-based content that can be analyzed using natural language processing techniques.

The term “natural language processing techniques” refers to computational methods and algorithms for processing and analyzing human language, including but not limited to tokenization, part-of-speech tagging, syntactic parsing, semantic analysis, sentiment analysis, intent detection, and classification.

The term “predefined abnormal patterns” refers to patterns of text or behavior that are specified in advance as being undesirable, harmful, inappropriate, suspicious, or otherwise non-normal, and that may be represented by rules, templates, keywords, regular expressions, machine-learned models, or any combination thereof.

The term “generative AI model” refers to a machine learning or artificial intelligence model configured to generate output data, such as natural language text, in response to input data or prompts, and may include, for example, large language models, transformer-based models, or other neural network-based generative architectures.

The term “input data” refers to information provided to the generative AI model, including but not limited to text derived from the user's data, representations of detected abnormal patterns, context information, and instructions encoded in prompts.

The term “prompt” refers to a structured input sequence provided to the generative AI model that includes instructions, context, and/or examples, and that is designed to cause the generative AI model to output a description, explanation, recommendation, or other response related to an abnormal pattern.

The term “abnormal pattern” refers to a particular instance of text or behavior that matches or is determined to correspond to one of the predefined abnormal patterns and is thereby treated as abnormal by the system.

The term “warning message” refers to information transmitted to the user to notify the user of the detection of an abnormal pattern, and may include a summary of the abnormal pattern, an explanation generated by the generative AI model, recommended actions, timestamps, severity levels, and other relevant information.

The term “real time” refers to an operational mode in which the system transmits a warning message to the user without substantial delay after detection of an abnormal pattern, such that the user is notified substantially concurrently with or immediately after the occurrence of the abnormal pattern.

The term “timing at which the user receives the warning message” refers to a point or schedule in time, or a set of conditions, that determines when a warning message is delivered to or made available to the user, including immediate delivery or delivery in batches at predetermined intervals.

The term “setting of the user” refers to configuration information specified or selected by the user, including preferences regarding notification mode, notification timing, grouping or batching of warning messages, and other operational parameters that influence how and when the system provides warnings and explanations.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

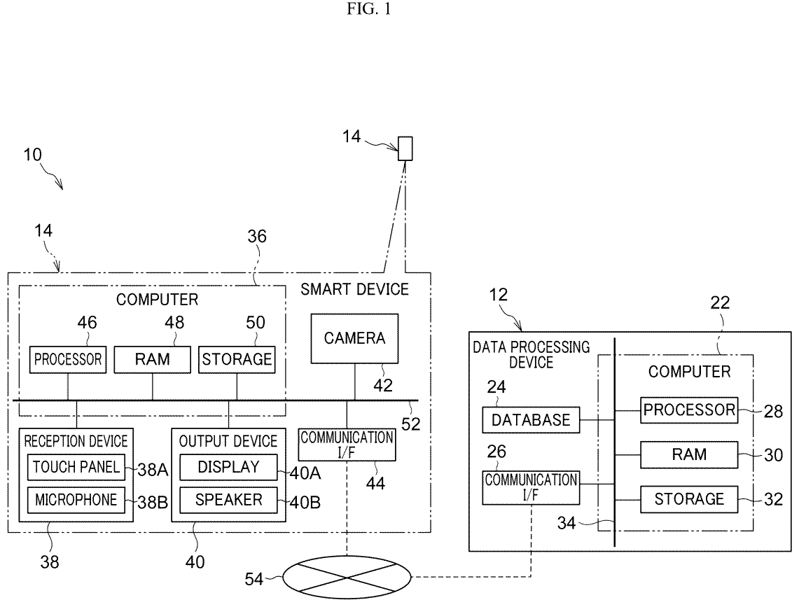

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

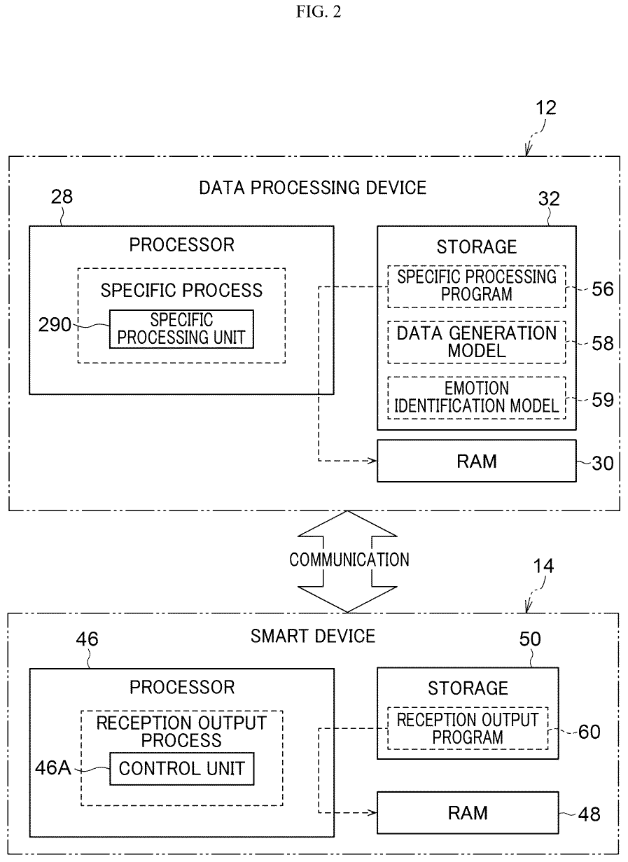

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional systems that analyze user communications typically apply fixed natural language processing pipelines and static rule sets on isolated text sources, such as email only or chat only. Such systems suffer from several technical limitations. First, when communication data spans multiple heterogeneous channels, including electronic messages and voice calls, conventional architectures require separate processing paths and manual correlation, which leads to fragmented context, increased memory usage, and redundant computation. Second, traditional anomaly or event detection engines rely on rigid pattern matching and pre-defined templates, which are not well suited to dynamically changing communication patterns and cannot flexibly extract higher-level semantics such as action items, deadlines, or emotional tone from free-form language. Third, when advanced machine learning models are used, they are often invoked with ad-hoc or hard-coded inputs, without a systematic layer that constructs, validates, and corrects model prompts and outputs, resulting in unstable behavior, parsing errors, and increased latency for retries.

In addition, existing systems do not effectively integrate speech recognition output, generative artificial intelligence output, and structured notification logic into a tightly coupled processing pipeline. For example, errors in voice recognition or inconsistencies in generative output formats can propagate through the system and cause malformed records, missing notifications, or excessive server-side error handling. These issues lead to unnecessary consumption of processing resources, complex exception handling code, and degraded responsiveness for real-time user notifications.

Furthermore, many systems lack a feedback-driven mechanism to adapt analysis rules and notification conditions based on actual user interaction with the results. Without such adaptation, servers continue to execute sub-optimal analysis tasks, send low-relevance alerts, and maintain inefficient resource allocation for model invocation and data aggregation. This prevents improvement of the underlying computer system performance in terms of throughput, latency, and effective use of model computation.

Accordingly, there is a need for a computer-implemented system and server architecture that (i) unifies multi-channel communication information, including text and speech-derived text, into a structured analysis target, (ii) programmatically constructs and manages prompt sentences for a generative artificial intelligence model, including re-prompting for structured output in case of abnormalities, and (iii) aggregates and prioritizes analysis results into notification candidates that are delivered in real time or according to user settings, while continuously updating analysis rules based on user feedback. Such a system should improve the functioning of the computer itself by reducing parsing failures, stabilizing model interaction, and optimizing server processing for large volumes of heterogeneous communication data.

The specific processing by the specific processing unit 290 of the data processing device 12 in Example 1 is realized by the following means.

The present invention provides a server comprising a processor configured to receive, via a communication network, communication information including electronic communication information and voice communication information from a user terminal, to generate text information from the voice communication information using a speech recognition processing service, to integrate the text information into analysis target information with associated metadata, to construct and supply structured prompt sentences to a generative artificial intelligence model based on analysis rules, to validate and, when necessary, correct analysis result information returned by the generative artificial intelligence model through generation of re-prompt sentences, to aggregate and rank corrected analysis result information to generate notification candidate information, and to control transmission of notification information including the analysis result information to the user terminal in real time or in accordance with user settings. This enables a technically improved computer-implemented processing pipeline that unifies heterogeneous communication streams, stabilizes interactions with the generative artificial intelligence model, reduces parsing and formatting errors, and optimizes server-side computation for generating timely, high-relevance notifications, thereby enhancing overall system efficiency and responsiveness.

The term “processor” refers to a hardware processing unit, such as a central processing unit or a graphics processing unit, and associated execution circuitry that executes program instructions to perform data processing operations described in this specification.

The term “user terminal” refers to an information processing device operated by a user, such as a portable terminal, a stationary terminal, or any other computing device capable of running an application and communicating with a server via a communication network.

The term “communication information” refers to data representing exchanges between users or between a user and a service, including but not limited to messages, call data, or other interaction data transmitted or received over a communication network.

The term “electronic communication information” refers to communication information composed primarily of text or structured digital content, such as electronic mail messages, chat messages, instant messages, and similar text-based communications.

The term “voice communication information” refers to communication information that includes audio data representing spoken language, such as audio streams or recordings of telephone calls, voice over network calls, or other speech-based interactions.

The term “communication network” refers to a wired or wireless data transmission infrastructure, including local networks, wide area networks, and public networks, that enables data exchange between the user terminal and the server.

The term “speech recognition processing service” refers to a software-implemented or hardware-accelerated function executed locally or remotely that analyzes voice communication information and converts the audio content into corresponding character information or text data.

The term “character information” refers to digital representations of symbols such as letters, numerals, and punctuation marks generated by processing voice communication information and forming the basis for text information.

The term “text information” refers to character information arranged as natural language strings or tokens, obtained from electronic communication information or converted from voice communication information, and suitable for natural language analysis.

The term “analysis target information” refers to structured data obtained by integrating text information and attaching metadata, such as communication type, time information, user identification information, and language type, for use as input to an analysis process.

The term “additional information” refers to metadata associated with analysis target information, including but not limited to communication type, time information, user identification information, language type, and other attributes that describe context of the underlying text.

The term “communication type” refers to a category that distinguishes different kinds of communication channels or media, such as electronic mail, chat, or voice call, associated with a given piece of communication information.

The term “time information” refers to temporal data associated with communication or analysis events, such as timestamps, time ranges, or dates that indicate when a communication occurred or when processing was performed.

The term “user identification information” refers to data that identifies or distinguishes a user or users associated with communication information, such as identifiers, pseudonymous labels, or account references.

The term “language type” refers to an indication of a natural language used in text information, such as a code or label that specifies the language in which the communication content is expressed.

The term “analysis rules” refers to one or more configurable sets of conditions and parameters that define how analysis target information is to be processed, including analysis items, output formats, importance determination conditions, and model operation conditions.

The term “analysis items” refers to specific categories or targets of analysis defined by analysis rules, such as extraction of important word information, summary information, emotion information, or action item information.

The term “output formats” refers to structural or syntactic specifications for how analysis result information is to be expressed, such as natural language text, tabular text, or structured data formats.

The term “importance determination conditions” refers to criteria or thresholds used to evaluate and assign levels of importance or priority to elements of analysis result information, such as keywords, tasks, or events.

The term “model operation conditions” refers to settings or parameters that control behavior of a generative artificial intelligence model, including model selection, temperature values, maximum output length, and other operational attributes.

The term “analysis instruction sentence” refers to a natural language string that instructs a generative artificial intelligence model how to process analysis target information, including which analysis items to perform and which output formats to produce.

The term “prompt sentence” refers to a natural language input string, including an analysis instruction sentence and embedded analysis target information, that is supplied to a generative artificial intelligence model in order to obtain analysis result information.

The term “generative artificial intelligence model” refers to a trained machine learning model capable of generating natural language or structured outputs in response to input prompt sentences, based on learned statistical relationships and patterns in data.

The term “analysis result information” refers to data output by the generative artificial intelligence model in response to a prompt sentence, including one or more of important word information, summary information, emotion information, and action item information.

The term “important word information” refers to words, terms, or phrases identified as salient within analysis target information, for example because they relate to key topics, entities, or events.

The term “summary information” refers to condensed natural language or structured descriptions that capture main points or essential content of the analysis target information in a shorter form.

The term “emotion information” refers to data indicating emotional characteristics of the communication, such as sentiment, attitude, or affective state derived from analysis of text information.

The term “action item information” refers to data that represents tasks, obligations, planned actions, or requested operations inferred from the analysis target information.

The term “machine-readable format” refers to a structured representation, such as a data structure or markup, that can be programmatically parsed and processed by a computer without human interpretation.

The term “data formats” refers to expected structural arrangements and types of data fields within analysis result information, such as string, numeric, or date fields, as defined by system specifications.

The term “value ranges” refers to permitted or expected numerical or categorical ranges or sets of values for fields included in analysis result information.

The term “item consistency” refers to logical coherence and alignment among related fields within analysis result information, such as matching identifiers, compatible dates, or non-contradictory attributes.

The term “re-prompt sentence” refers to a prompt sentence generated in response to detection of an abnormality in analysis result information, which instructs the generative artificial intelligence model to output corrected or more strictly structured data.

The term “structured output” refers to generative artificial intelligence model output that conforms to a predefined structural specification, such as a particular data schema or machine-readable format.

The term “corrected analysis result information” refers to analysis result information that has been updated, refined, or replaced based on validation checks and outputs obtained using a re-prompt sentence.

The term “notification candidate information” refers to intermediate data representing analysis results that have been aggregated and ranked, and that are selected as candidates for generation of notification information to be provided to a user.

The term “aggregation” refers to a process of combining multiple items of analysis result information into grouped or summarized forms, based on criteria such as time information, communication type, or topic.

The term “ranking” refers to assigning an order or priority to items of analysis result information or notification candidate information according to importance determination conditions or other weighting criteria.

The term “notification information” refers to data that is transmitted to a user terminal to inform a user of analysis results, including content derived from analysis result information and associated metadata such as priority or timing.

The term “priority information” refers to data indicating relative importance or urgency of items included in notification information, such as rankings or priority levels.

The term “deadline information” refers to temporal constraints or due dates associated with action item information, indicating when a task or obligation should be completed.

The term “screen display” refers to a visual presentation of notification information on a display device of a user terminal, including graphical user interfaces or text interfaces.

The term “electronic notification” refers to a notification transmitted and presented in an electronic form other than a screen display of a running application, such as a system notification, message alert, or other digital signaling.

The term “voice guidance” refers to audio output provided to a user, in which notification information is presented through synthesized or recorded speech.

The term “user settings” refers to configuration information provided by a user that controls operation of the system, including timing of notifications, selection of communication channels, or preferred types of analysis.

The term “setting information” refers to data representing user settings or other configuration parameters used to control analysis rules, notification generation, or other behaviors of the system.

The term “operation history information” refers to data representing records of user interactions with analysis result information or notification information, such as confirmations, dismissals, modifications, or feedback actions.

The term “generation conditions of the notification candidate information” refers to rules or parameters that determine when and how notification candidate information is created from analysis result information, including thresholds, filtering criteria, and aggregation policies.

The server executes an operating system such as a general-purpose server operating system and runs application software implemented for example using a server-side framework. The server further has access to a database management system, such as a relational database system or a document-oriented database system, and may use a message queue system for asynchronous processing. The terminal executes a client operating system such as a mobile or desktop operating system and runs an application that communicates with the server via a packet-switched communication network, such as the Internet, using a secure transport protocol such as TLS.

The terminal acquires communication information of the user from multiple channels. The terminal obtains electronic communication information from applications that manage email, instant messaging, and group chat. The terminal uses system-level APIs or software libraries to access message content, sender and recipient data, and timestamps. The terminal further acquires voice communication information by capturing audio data from telephony or voice-over-network APIs. The terminal uses the built-in microphone and audio subsystem to obtain digitized audio signals representing the user's speech. The terminal encodes the audio signals, for example as PCM or compressed audio frames, and stores the encoded frames in a buffer in main memory.

The terminal converts the voice communication information into text information by using a speech recognition processing service. The terminal transmits audio frames to a speech recognition service provided either on the server or on an external computing infrastructure. In one embodiment, the terminal uses a cloud speech recognition API provided by a generic cloud service provider, which internally implements a deep neural network-based automatic speech recognition model. The terminal sends the audio with metadata such as language code, sampling rate, and channel count via HTTPS requests. The terminal receives, as responses, character information segments corresponding to recognized words. The terminal concatenates the segments into text strings forming a transcript of the call. The terminal associates the transcript with metadata including call start time, call end time, caller identity, and callee identity.

The server receives communication information from the terminal. The server accepts HTTPS requests containing electronic communication information and text information converted from voice communication. The server decrypts the TLS stream and, if necessary, performs additional payload decryption using a symmetric encryption algorithm. The server parses the received data as structured messages, each containing a communication identifier, channel type, timestamp, language type, and text content. The server stores the structured messages in a storage subsystem such as a relational table or a document collection.

The server constructs analysis target information by integrating the text information with additional information. The server merges related messages by a conversation identifier, a time window, or a participant set. The server generates analysis target records, each record including: a communication type field indicating whether the source is email, chat, or call; a time information field including timestamps or time intervals; a user identification field denoting the user; a language type field; and a text content field containing a concatenated or otherwise normalized text. The server may also include derived attributes such as estimated topic labels or channel source tags. The server stores the analysis target records in a designated analysis table or collection, indexed by user and time.

The server maintains analysis rules. The server stores, for each user or group of users, rule sets describing analysis items, output formats, importance determination conditions, and model operation conditions. The server may store these rules as structured configuration records in a database. The analysis items specify what should be extracted from the analysis target information, such as important word information, summary information, emotion information, and action item information. The output formats define whether results are expected as free-form natural language or as specific structured formats. The importance determination conditions define scoring functions and thresholds based on keywords, temporal proximity, or semantics. The model operation conditions include parameters such as model name selection, maximum token length, and sampling temperature.

The server constructs a prompt sentence for a generative AI model by combining the analysis rules with the analysis target information. The server generates an analysis instruction sentence in natural language, for example in English or the language indicated by the language type field. The server embeds the text content and relevant metadata into the instruction sentence. As one example, the server constructs a prompt sentence such as:
“The following text is a user's email thread. Identify the main topic, extract up to 10 important keywords, and list any explicit tasks with due dates. Output the result as JSON with fields ‘topic’, ‘keywords’, and ‘tasks’ (each task has ‘description’ and ‘due_date’). Text: [EMAIL_TEXT].”

As another example, when the source is a voice call transcript, the server constructs a prompt sentence such as:
“The following is a transcript of a phone call converted from speech to text. Perform sentiment analysis (positive, neutral, negative), summarize the main concerns in no more than 5 sentences, and list any commitments made by the user. Output JSON with fields ‘sentiment’, ‘summary’, and ‘commitments’. Transcript: [CALL_TRANSCRIPT].”

For mixed communications over a day, the server constructs a prompt sentence such as:
“Below is a mixed log of the user's emails, chats, and call transcripts from today. Generate a concise daily brief that the user can read in under 2 minutes. Include sections: ‘Key Topics’, ‘Deadlines’, and ‘Action Items’. Use bullet points. Text log: [MIXED_LOG].”

The server may also construct a refinement prompt sentence such as:
“You are given noisy extracted tasks from multiple communications. Clean up the wording, remove duplicates, and sort them by urgency (today, this week, later). Output JSON with fields ‘today’, ‘this_week’, and ‘later’, each containing a list of task descriptions. Tasks: [RAW_TASKS].”

The server inputs the prompt sentence into a generative AI model. The generative AI model may be implemented as a transformer-based neural network comprising multiple attention layers, feedforward layers, and layer normalization components. The model uses a tokenization scheme to convert the prompt sentence into a sequence of tokens. The model then performs forward propagation through its network: each layer applies self-attention to compute token representations conditioned on other tokens, followed by non-linear transformations. The model parameters consist of weight matrices and bias vectors trained on large text corpora using supervised and unsupervised learning objectives, such as next-token prediction and masked language modeling. The model is trained using backpropagation with an error function such as cross-entropy loss. During training, a gradient-based optimization algorithm, for example stochastic gradient descent with adaptive learning rate, updates the weights. Data augmentation techniques, such as random masking of tokens or shuffling of sentence order within bounds, may be employed to improve generalization.

At inference time, the server invokes the generative AI model via an API call. The server supplies the prompt sentence and model operation conditions, including maximum generation length and temperature. The generative AI model generates an output sequence by iteratively computing the probability distribution over the vocabulary for the next token given previous tokens and selecting tokens according to the specified decoding strategy. The server receives the generated output as text.

The server interprets the generated text as analysis result information. The server attempts to parse the portions designated in the prompt sentence as structured data. The server verifies that the output conforms to expected data formats, value ranges, and item consistency. For example, the server checks that dates match a predetermined format, that keywords are non-empty strings, and that each task item has both a description and a due date. The server uses deterministic parsing algorithms and schema validators implemented in software libraries to perform these checks.

When the server detects an abnormality in the analysis result information, such as syntactic errors, missing fields, or inconsistent values, the server generates a re-prompt sentence. The server constructs the re-prompt sentence to instruct the generative AI model to output only structured data in a specific format without additional explanatory text. For example, the server constructs a sentence such as:
“Return only valid JSON with fields ‘topic’, ‘keywords’, and ‘tasks’ (each task has ‘description’ and ‘due_date’) without any explanation. Correct the following malformed result: [PREVIOUS_OUTPUT].”

The server then re-invokes the generative AI model with the re-prompt sentence. This loop of validation and re-prompting corrects the analysis result information. Because the server performs structural validation and targeted re-prompting, the system reduces parsing failures and minimizes manual exception handling logic. The server thus improves the stability of the entire analysis pipeline.

The server aggregates corrected analysis result information into notification candidate information. The server stores for each piece of analysis result information an importance score derived from the importance determination conditions. These conditions may include weighting based on presence of explicit deadlines, semantic categories of tasks, or sentiment indicators. The server performs aggregation operations such as grouping by date, by communication channel, or by topic. The server applies ranking procedures, such as sorting by score or applying a priority queue data structure, to determine which items should be presented first to the user. The server discards or demotes items below a defined threshold. This aggregation and ranking reduce communication load by selecting only high-relevance items for notification.

The server generates notification information based on the notification candidate information. The notification information includes action item information and deadline information with associated priority information. The server formats the notification information as messages that can be rendered as screen displays or delivered as electronic notifications or voice guidance. The server schedules or triggers transmission according to user settings and system conditions. The server transmits the notification information to the terminal via the communication network.

The terminal presents the notification information to the user. The terminal displays the content on a display device using a user interface framework. The terminal may highlight high-priority tasks, show deadlines in an emphasized format, and provide links back to the original communications. Alternatively or additionally, the terminal produces an audible presentation by converting the notification information into synthesized speech using a text-to-speech engine. The user views or listens to the notification and can interact with it, for example by marking tasks as completed or dismissing certain alerts.

The server updates analysis rules based on setting information and operation history information. The server tracks user interactions with the notification information, such as which notifications are opened, which tasks are accepted or rejected, and which summaries are expanded. The server stores these interactions as operation history information. The server also receives setting information from the user, including preferences such as which channels to monitor more closely and which types of alerts are most useful. The server applies adaptation algorithms to adjust analysis rules. For example, the server may increase importance weights for categories that the user frequently acts upon and reduce weights for categories often ignored. By updating rules in this data-driven manner, the server improves the match between analysis output and user needs without modifying the generative AI model itself.

This configuration yields concrete technical effects that go beyond a mere automation of human reading of communications. The server unifies heterogeneous communication streams in a structured analysis target format and enforces strict validation and re-prompting mechanisms around the generative AI model. As a result, the server reduces the number of malformed outputs that would otherwise require extensive ad-hoc error-handling code. The server thereby decreases CPU usage for exception handling, reduces memory consumption for storing erroneous records, and shortens average response time for generating usable results. The server's aggregation and ranking algorithms, applied prior to notification transmission, limit the volume of data that must be sent to the terminal, thus reducing communication bandwidth usage and improving latency.

Furthermore, by treating the generative AI model as a controlled component within a larger deterministic pipeline, the server improves effective model utilization. The server selects model operation conditions that balance accuracy and token usage, and the validation-and-re-prompt cycle avoids repeated failures. Compared with a naive approach that calls the model with static prompts and accepts arbitrary outputs, this architecture reduces the number of model invocations required to obtain valid structured data, which lowers computational load on the model provider infrastructure and accelerates overall processing.

The terminal contributes to technical improvement by performing pre-processing close to the data source. By capturing audio and invoking the speech recognition processing service early, the terminal reduces the need for the server to handle raw high-bitrate audio streams. The server instead processes compressed text data, which requires less bandwidth and storage. The division of labor between terminal and server thus optimizes data flow and resource allocation.

In contrast to conventional rule-based systems that use static patterns, the described system leverages a generative AI model configured by prompt sentences and surrounded by validation logic. The model does not simply mimic human judgment; instead, it performs high-dimensional vector computations and attention-based contextual reasoning that identify implicit tasks, deadlines, and emotional cues across long sequences. The server's non-conventional use of prompt construction, structural validation, and feedback-driven rule updates yields a computer-centric improvement: the pipeline becomes more robust against noisy input, transcription errors, and free-form language variation, thereby enhancing precision and recall of extracted items while maintaining or improving throughput.

Various modifications and alternative embodiments are possible within this framework. In another embodiment, the server executes the speech recognition processing locally using a neural network model deployed on a dedicated accelerator, rather than relying on an external service. In another embodiment, the generative AI model resides on an on-premise inference server using a quantized transformer model for lower latency. In another embodiment, the aggregation step uses graph-based clustering of related tasks across multiple days, rather than simple temporal grouping, to identify long-term projects. In another embodiment, the terminal performs an initial keyword extraction using a lightweight statistical model, and the server uses these keywords as additional features embedded into the prompt sentence to guide the generative AI model.

In all such embodiments, the core concept remains that the server structures heterogeneous communication streams as analysis target information, constructs and manages prompt sentences for a generative AI model with explicit validation and correction, aggregates and prioritizes analysis results, and transmits notifications tailored in timing and content to the user through the terminal. By implementing these mechanisms in concrete hardware and software components, the system improves performance, reliability, and efficiency of computer-implemented communication analysis.

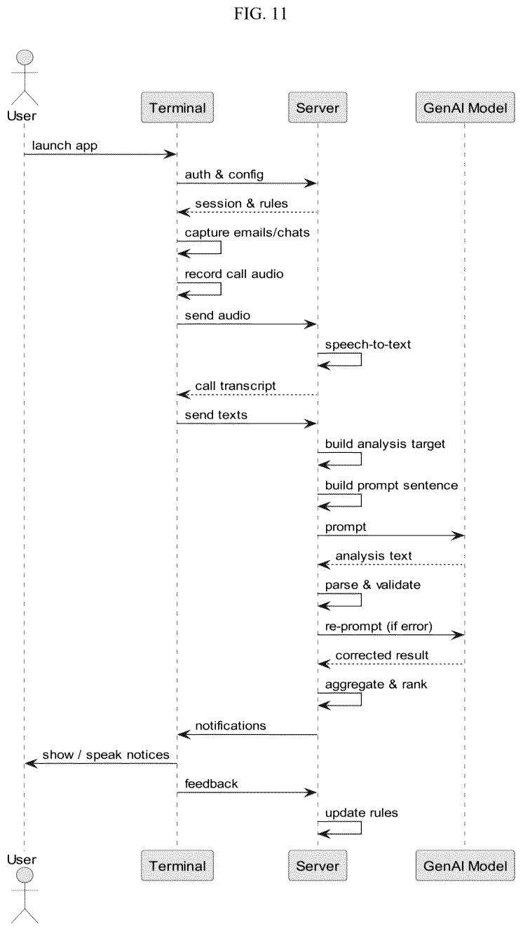

The following describes the processing flow using FIG. 11.

### Step 1

The user launches an application on the terminal. The input is a user action such as tapping an icon or clicking a shortcut. The terminal receives this input through the operating system event dispatcher and starts an application process. The terminal loads configuration data from local storage, including server endpoint information, user identification information, and monitoring settings, and outputs an initialized application state stored in main memory.

### Step 2

The terminal establishes a secure communication channel with the server. The input is the initialized application state containing the server address and authentication credentials. The terminal performs a TLS handshake with the server, verifies a server certificate, and sends an authentication token. The server receives the authentication token, validates it against stored user records in a database, and outputs a session context that includes a session identifier and permission information.

### Step 3

The terminal acquires electronic communication information from local communication applications. The input is access rights and configuration specifying which email accounts and chat services to monitor. The terminal calls system APIs or software libraries to retrieve email message data and chat message streams, including headers, body text, sender, recipient, and timestamps. The terminal performs data extraction by parsing protocol structures (for example, MIME or message objects) and outputs normalized electronic communication records in a structured format stored in an in-memory buffer.

### Step 4

The terminal acquires voice communication information from telephony or voice-over-network interfaces. The input is notification from the operating system that a voice call has started and microphone audio signals. The terminal connects to the audio subsystem, captures audio frames at a specified sampling rate, and encodes the raw samples into a digital audio format such as PCM frames. The terminal outputs a sequence of timestamped audio frames representing the ongoing call and stores them in a circular buffer.

### Step 5

The terminal converts voice communication information into text information using a speech recognition processing service. The input is the sequence of audio frames with associated timestamps and language settings. The terminal segments the audio into chunks of a predetermined duration, compresses or formats the chunks if needed, and constructs requests to a speech recognition API. The terminal sends the audio chunks to the service, receives recognition results as character sequences with confidence scores, and concatenates the sequences into a transcript. The terminal outputs call transcript text associated with call metadata and stores it as text information.

### Step 6

The terminal transmits electronic communication information and text information to the server. The input is the normalized electronic communication records and call transcript text stored in the in-memory buffer. The terminal packages these records into request messages, encrypts the payload using a symmetric algorithm if configured, and sends the messages via HTTPS to the server. The server receives the messages, decrypts the transport and payload as required, parses the JSON or similar structure, and outputs structured communication items ready for further processing.

### Step 7

The server constructs analysis target information from the structured communication items. The input is a set of communication items that include text content, communication type, time information, and user identification information. The server groups items by conversation identifier, topic key, or time window by performing sorting and grouping operations on the data. The server consolidates the text content into a single field per group, attaches metadata such as communication type, language type, and participant identifiers, and computes derived attributes such as conversation duration. The server outputs analysis target records that encapsulate all these fields and stores them in an analysis data store.

### Step 8

The server selects analysis rules for each analysis target record. The input is an analysis target record and rule configuration data retrieved from a configuration database. The server evaluates conditions such as communication type, language type, and user preferences, and chooses appropriate analysis items, output formats, importance determination conditions, and model operation conditions. The server performs rule matching using a decision tree or rule engine and outputs a selected rule set bound to the corresponding analysis target record.

### Step 9

The server generates a prompt sentence for a generative AI model based on the analysis target record and the selected rule set. The input is the analysis target text content and rule parameters that describe what must be extracted or summarized. The server constructs an analysis instruction sentence by inserting rule-defined phrases and placeholders, then embeds the text content and relevant metadata into this sentence. The server may insert explicit field names and expected output format instructions. The server outputs a complete prompt sentence as a natural language string and stores it as part of a model request object.

### Step 10

The server supplies the prompt sentence to the generative AI model and obtains analysis result information. The input is the prompt sentence and model operation conditions such as maximum token count and temperature. The server sends the prompt to the generative AI model service via an API, which tokenizes the prompt and performs forward propagation through its neural network layers to compute probability distributions over tokens and generate output text. The server receives the generated text response, associates it with the originating analysis target record, and outputs raw analysis result information as textual content.

### Step 11

The server parses and validates the analysis result information. The input is the raw analysis result text and the expected output format defined in the rule set. The server applies a parser to extract structured components, such as keywords, summaries, sentiment labels, and tasks, from marked portions of the text. The server checks data formats of fields, verifies that dates conform to a specified pattern, and ensures that all required fields are present and logically consistent. The server outputs either validated structured analysis result information or an error status indicating abnormalities.

### Step 12

The server generates and sends a re-prompt sentence when abnormalities are detected. The input is the original prompt sentence, the malformed analysis result information, and validation error details. The server constructs a re-prompt sentence that explicitly instructs the generative AI model to correct the errors and output only structured data in the required format. The server embeds the previous output and error description into the instruction if desired. The server sends this re-prompt sentence to the generative AI model, receives corrected output, and outputs updated analysis result information with improved structure and consistency.

### Step 13

The server aggregates and ranks corrected analysis result information into notification candidate information. The input is a collection of validated or corrected analysis result records for a given user over a time period. The server computes importance scores for each record using the importance determination conditions, which may involve weighting factors for deadlines, task urgency, sentiment intensity, or keyword categories. The server groups related records by day, by topic, or by project identifier, and applies sorting algorithms to rank them by score. The server outputs notification candidate information, which is a reduced set of high-priority records prepared for notification generation.

### Step 14

The server generates notification information from the notification candidate information. The input is the prioritized notification candidates and user settings specifying notification channels and timing. The server formats the content into notification messages, which include action item information, deadline information, and summary information, along with associated priority indicators. The server encodes these messages into structures suitable for screen display, push notification, or voice guidance. The server outputs notification payloads and schedules them for transmission.

### Step 15

The server transmits the notification information to the terminal. The input is the notification payloads with destination identifiers and timing parameters. The server sends the payloads via a notification service or direct HTTPS responses, using the communication network. The terminal receives the payloads, verifies their integrity and authenticity, and stores the notification data in local storage. The terminal outputs a set of notification objects ready for presentation to the user.

### Step 16

The terminal presents the notification information to the user. The input is the set of notification objects and the terminal's user interface configuration. The terminal renders the notification content on a display, generating user interface elements such as lists, icons, and highlight markers to represent priority and deadlines. Alternatively or additionally, the terminal converts the notification text into audio using a text-to-speech engine and plays it through a speaker. The terminal outputs visual or audio signals that the user can perceive and interact with, such as tapping, swiping, or selecting options.

### Step 17

The terminal and the user provide feedback information to the server. The input is user actions on the notification interface, such as marking tasks as completed, dismissing alerts, or adjusting settings. The terminal captures these operations as structured events and associates each event with the relevant notification identifier and analysis result identifier. The terminal sends the feedback events to the server via HTTPS. The server receives the events, stores them as operation history information, and outputs updated user interaction logs.

### Step 18

The server updates analysis rules and notification generation conditions based on the feedback. The input is operation history information and existing rule configurations. The server analyzes patterns in the user responses, for example by counting how often certain categories of notifications are ignored or quickly acted upon. The server applies update algorithms that adjust rule parameters such as importance weights, threshold values, and preferred analysis items. The server writes the updated rules back to the configuration storage and outputs revised rule sets that will be applied to subsequent analysis target records.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional communication security systems typically rely on static rule sets or fixed machine learning classifiers that operate on limited types of data, such as text-based messages or pre-filtered email content. These systems are often implemented as independent modules with minimal integration between text analysis, audio analysis, and user interaction. As a result, such systems suffer from several technical drawbacks in terms of computer technology.

First, known systems generally treat text data and audio data in isolation, or do not handle audio communication content at all. This leads to underutilization of available communication streams and results in incomplete threat detection coverage. When audio content is not converted into a text representation and integrated into the same analysis pipeline as text messages, the processing device cannot efficiently apply uniform natural language processing and anomaly detection across heterogeneous data types, thereby reducing detection accuracy and throughput.

Second, traditional anomaly detection pipelines are typically hard-coded and do not adapt based on user interaction feedback. When a processor outputs warning messages that are static or template-based, the system cannot refine its abnormal pattern determination logic or notification logic over time. The lack of feedback-driven updates leads to suboptimal utilization of computational resources, such as maintaining ineffective rules, and degrades the precision and recall of threat detection across large-scale communication traffic.

Third, existing systems often generate warnings directly from rule-based outputs, without using a generative artificial intelligence model to synthesize context-aware, concise, and user-appropriate prompt sentences. This results in warning messages that are either overly technical or too generic, causing users to ignore them or misinterpret their severity. From a computing perspective, this also represents an inefficient use of information already computed by the anomaly detection engine, because detailed context (for example, extracted features, risk indices, and threat categories) is not systematically integrated into the generation of the final warning output.

Fourth, many systems lack an integrated mechanism for transforming heterogeneous communication content into a normalized internal representation, then using that representation to drive both anomaly detection and dynamic warning generation in a coordinated manner. Without such normalization and coordinated processing, the processor must maintain multiple code paths and data structures, increasing memory usage, processing latency, and implementation complexity. This, in turn, reduces the scalability and robustness of the system when deployed in high-throughput environments.

Accordingly, there is a need for an improved computer-implemented system and method that: (i) normalizes multiple types of communication content data, including text and audio, into a unified internal format; (ii) applies natural language processing techniques and abnormal pattern detection uniformly across these normalized representations; (iii) leverages a generative artificial intelligence model to generate context-aware warning prompt sentences that reflect detailed detection results; and (iv) updates anomaly detection and context generation processes based on user feedback. Such an improvement would enhance the technical functioning of the processor, increase efficiency and coverage of security analysis, and improve the effectiveness of user-facing warnings in real-time or user-configurable timeframes.

The specific processing by the specific processing unit 290 of the data processing device 12 in Application Example 1 is realized by the following means.

The present invention provides a server comprising a processor configured to receive, from a communication endpoint device via a communication path, communication content data of multiple types, normalize the communication content data into an internal format including a text representation and associated information, analyze, using a natural language processing technique, the text representation included in the normalized communication content data by performing at least linguistic analysis, feature calculation, and comparison with a predefined abnormal pattern to determine whether the communication content data includes a security threat, when the communication content data includes audio information, convert the audio information into the text representation by an automatic speech recognition function and add the text representation as an additional target of analysis and abnormal pattern determination, generate context information including a detection result of the abnormal pattern, identification information extracted from the communication content data, reference information, and a risk index, provide the context information as input data to a generative artificial intelligence model, cause the generative artificial intelligence model to generate, based on the context information, a prompt sentence including at least warning content, recommended actions, and confirmation items to be presented to a user, select, from a generated result, a warning prompt sentence that satisfies a predetermined length, expression style, and risk level, transmit the selected warning prompt sentence as notification information to the communication endpoint device so that the warning prompt sentence is presented to the user in real time or in accordance with user-specified display conditions, and acquire, from the communication endpoint device, operation information and evaluation information of the user with respect to the notification information and update an abnormal pattern determination process and a context information generation process for the generative artificial intelligence model based on the evaluation information. This enables the server to technically improve the processing of heterogeneous communication content by unifying text and audio data into a common analytical pipeline, enhance threat detection efficiency and accuracy through integrated natural language processing and feedback-driven refinement, and generate context-aware warning prompt sentences via the generative artificial intelligence model that are computationally optimized for length, style, and risk level, thereby providing more effective and timely security notifications while reducing processing overhead and complexity within the communication security system.

The term “system” refers to a combination of hardware and software components that cooperate to perform communication data acquisition, analysis, threat detection, and warning notification processing as described in the claims.

The term “processor” refers to one or more hardware processing units, such as a central processing unit or a processing core of an integrated circuit, executing machine-readable instructions to implement the described functions.

The term “communication endpoint device” refers to an information processing device used by a user, such as a terminal, client device, or user equipment, that sends communication content data to the server and receives notification information.

The term “communication path” refers to a wired or wireless communication network or channel, including any protocol stack, through which data is transmitted between the communication endpoint device and the server.

The term “communication content data” refers to information representing user communications, including but not limited to text messages, email content, chat messages, audio data, and associated metadata.

The term “multiple types” refers to different categories or modalities of communication content data, such as text-based data and audio-based data, which may be processed in a unified manner.

The term “internal format” refers to a normalized data structure used within the server to represent communication content data, including a text representation and associated information, in a consistent manner independent of the original source format.

The term “text representation” refers to a character-based form of communication content, including text originally provided as text and text derived from conversion of audio information.

The term “associated information” refers to metadata or contextual information linked to the communication content data, such as timestamps, sender and recipient identifiers, application identifiers, or communication channel information.

The term “normalize” refers to converting heterogeneous communication content data into a standardized internal format, including harmonizing encodings, structures, and fields to enable unified processing.

The term “natural language processing technique” refers to a computational method for analyzing human language text, including operations such as tokenization, parsing, feature extraction, and semantic or syntactic analysis.

The term “linguistic analysis” refers to processing steps applied to text representation, such as morphological analysis, syntactic analysis, phrase extraction, or other language-structure-related operations.

The term “feature calculation” refers to computing numerical or categorical attributes derived from the text representation, such as term frequencies, keyword presence, URL characteristics, or statistical measures used for abnormal pattern detection.

The term “predefined abnormal pattern” refers to a pattern of features, rules, or model-based conditions configured in advance to indicate a potential security threat in communication content data.

The term “security threat” refers to an undesirable or malicious activity indicated by communication content data, such as phishing, fraud, unauthorized access attempts, or social engineering.

The term “audio information” refers to data representing sound, including spoken communication in voice calls, voice messages, or other audio-based interactions.

The term “automatic speech recognition function” refers to a computational function or service that converts audio information, such as speech, into a corresponding text representation.

The term “context information” refers to structured information generated based on analysis of the communication content data, including detection results, identification information, reference information, and a risk index.

The term “detection result of the abnormal pattern” refers to information indicating whether a predefined abnormal pattern has been detected in the communication content data and, if detected, the type or category of the abnormal pattern.

The term “identification information” refers to information extracted from the communication content data that can identify or characterize the communication, such as sender identifiers, recipient identifiers, or communication IDs.

The term “reference information” refers to auxiliary information used to interpret or further describe the communication content data or detection result, such as extracted URLs, domain names, or related context.

The term “risk index” refers to a numerical or categorical indicator representing an estimated level of risk or severity associated with the communication content data.

The term “generative artificial intelligence model” refers to a trained machine learning model capable of generating natural language text, such as warning messages or explanations, based on input context information.

The term “prompt sentence” refers to a text output generated by the generative artificial intelligence model, instructing or informing the user regarding detected threats, recommended actions, or confirmation requests.

The term “warning content” refers to information within a prompt sentence that alerts the user to a potential security threat in the communication content data.

The term “recommended actions” refers to suggested operations or responses presented to the user, such as not opening a link, verifying a sender, or deleting a message.

The term “confirmation items” refers to questions or requests for confirmation presented to the user to verify the user's intention or understanding of the warning.

The term “warning prompt sentence” refers to a selected prompt sentence that includes warning content, recommended actions, and confirmation items, and is intended to be displayed to the user as a notification.

The term “predetermined length” refers to a length constraint, such as a maximum number of characters or words, applied to a warning prompt sentence to satisfy display or transmission requirements.

The term “expression style” refers to stylistic properties of a prompt sentence, such as tone, formality, clarity, and target audience adaptation.

The term “risk level” refers to a classification or degree of severity associated with a detected security threat, used to select or adjust the content of a warning prompt sentence.

The term “notification information” refers to data transmitted from the server to the communication endpoint device, including at least the warning prompt sentence and optionally additional metadata for presentation.

The term “real time” refers to a manner of processing or presenting information with a delay sufficiently short that the information remains relevant to an ongoing or recently received communication, as perceived by the user.

The term “user-specified display conditions” refers to conditions or preferences defined by the user, such as time periods, priority levels, or frequency settings, governing when and how notification information is presented.

The term “operation information” refers to information indicating how the user interacted with the notification information, such as whether the user opened, dismissed, or followed a recommended action.

The term “evaluation information” refers to feedback from the user regarding the notification information or detection result, such as indications that a warning was accurate, inaccurate, helpful, or unhelpful.

The term “abnormal pattern determination process” refers to a sequence of operations executed by the processor to decide whether communication content data matches a predefined abnormal pattern and thus indicates a security threat.

The term “context information generation process” refers to a sequence of operations for constructing the context information to be provided to the generative artificial intelligence model, including selection, aggregation, and formatting of relevant analysis data.

The term “update” refers to modifying parameters, rules, models, or procedures associated with the abnormal pattern determination process or context information generation process based on newly acquired operation information or evaluation information.

In one embodiment, the system includes a server, one or more terminals, and a communication network that connects the server and the terminals. The server includes at least one hardware processor, a main memory, a non-volatile storage device, and a network interface controller mounted on a computing platform. The terminal includes a processor, a memory, a display, a microphone, and a wireless or wired communication interface. The server executes server-side software modules, and the terminal executes client-side software modules, to implement the functions described below.

The server uses a general-purpose computing device, such as a rack-mounted computer or a virtual machine in a data center, equipped with a multi-core central processing unit and optionally a graphics processing unit. The server runs an operating system, such as a server-class operating system, and executes an application framework such as a web application framework or an application server. The server stores program instructions and data structures in memory and persistent storage, including a relational database management system or a document-oriented database, and optionally a distributed message queue.

The terminal uses a mobile device, a tablet, or a personal computer operated by the user. The terminal runs a client operating system, such as a mobile operating system or a desktop operating system, and executes a client application that cooperates with the server. The terminal application accesses communication content through application programming interfaces of email clients, chat applications, and voice call applications, and obtains user interface resources from the operating system, such as notification channels and system dialogs.

The terminal acquires communication content data from applications running on the terminal. The terminal accesses text messages, such as emails and chat messages, through application-level interfaces or content provider interfaces, and converts the messages into text strings in a unified character encoding. The terminal acquires audio information from an audio input device, such as a microphone, through an audio input interface provided by the operating system. The terminal compresses the audio information into a compressed audio format or a linear audio format, and associates the audio with metadata such as timestamps, caller identifiers, and application identifiers. The terminal then constructs a structured data object that includes text representation fields, audio data fields, and associated information fields, and stores this object in a local buffer before transmission.

The server receives communication content data from the terminal over the communication network. The server uses a network interface controller to accept transport-layer packets and reconstruct application-layer messages, such as secure HTTP requests. The server parses incoming messages and extracts the structured data object containing the communication content data. The server stores the structured data object into a database or a message queue with fields such as message identifier, user identifier, channel type, raw text, audio reference, and metadata. By storing data in a normalized internal format, the server reduces the need for repeated format conversions and improves cache locality when processing large volumes of data.

The server converts heterogeneous communication content into an internal format suitable for natural language processing and anomaly detection. The server normalizes text representation fields by applying operations such as character normalization, lowercasing where appropriate, removal of control characters, and standardization of whitespace. The server also extracts embedded resources such as uniform resource locators, email addresses, and numerical codes, and stores them into dedicated fields with structured subcomponents (for example, domain, path, query parameters). The server formats the audio data into a representation supported by an automatic speech recognition engine, such as a linear pulse-code modulation sequence, if the original format is not directly compatible.

The server uses a natural language processing library, such as a statistical or neural language processing framework, to perform linguistic analysis on the text representation. The server applies tokenization to divide the text into tokens and sentences, and applies part-of-speech tagging and syntactic parsing to infer grammatical structure. The server performs named-entity recognition to identify entities such as organizations, financial institutions, and personal identifiers. The server also computes features derived from the text, including frequency of certain keywords, entropy measures of character sequences in URLs, deviations from typical writing style models, and co-occurrence patterns of security-relevant phrases.

The server processes audio information by converting it into an additional text representation. The server sends audio samples to a speech recognition component, which may run locally on the server or as a remote service. The server configures the speech recognition component with parameters such as language model, sampling rate, and noise reduction options. The server receives recognized text with time-aligned segments and integrates the recognized text into the same internal representation used for other text messages. This integration allows a single anomaly detection pipeline to operate across both originally textual and originally audio communication modalities, which increases processing efficiency and reduces duplicated code paths.

The server performs abnormal pattern determination using a combination of rule-based logic and machine learning algorithms. The server defines a set of abnormal patterns in the form of rules that operate on the internal representation, such as rules identifying unusual domain patterns, excessive use of urgency expressions, or requests for one-time codes within a short time window. The server also uses a classification model, for instance a neural network implemented with a multilayer architecture or a tree-based ensemble model, to compute a risk index for each communication. In one embodiment, the server implements a feed-forward neural network or a transformer-based encoder that accepts a sequence of token embeddings derived from the text representation and produces a probability vector representing different threat categories.

The server trains the anomaly detection model using labeled training data collected from prior communications and user feedback. The server defines a loss function, such as cross-entropy loss for multi-class classification, and uses an optimization algorithm, such as stochastic gradient descent or an adaptive gradient method, to update model weights. The server performs data augmentation techniques, such as random masking of benign phrases or perturbation of message order, to improve model generalization and robustness. The server periodically retrains the model or fine-tunes it using newly collected data to maintain high accuracy in the presence of evolving attack patterns.

The server generates context information when an abnormal pattern is detected or when the risk index exceeds a threshold. The server compiles a structured context that includes the detection result, the affected message segment, one or more extracted resources such as URLs, a numerical risk index, and metadata describing the communication channel and time. The server adds explanatory features, such as which rules were triggered and which tokens contributed most to the model's risk score, and stores these in a context object. By explicitly encoding feature-level explanations, the server enables downstream components to generate more precise and concise user-facing messages, which reduces ambiguity and improves user comprehension.

The server uses a generative AI model to generate a prompt sentence based on the context information. In one embodiment, the server deploys a sequence-to-sequence neural network model or a transformer-based language generation model trained on security-related guidance text and general-purpose language data. The generative AI model includes multiple layers of self-attention and feed-forward sublayers, parameterized by a large number of weights learned from training data. The server encodes the context information into a textual prompt that includes system-level instructions, a brief description of the detection result, and selected excerpts of the suspicious communication. The server then sends this encoded prompt to the generative AI model, which generates candidate output sentences token by token using a decoding algorithm such as beam search or top-k sampling constrained by length and style parameters.

The server configures the generative AI model with parameters such as a maximum token length, an output temperature to control randomness, and stylistic instructions to maintain a concise, neutral, and user-friendly tone. The server discards outputs that exceed allowed length or that do not meet predefined style constraints, such as inclusion of unsupported characters or overtly technical jargon. The server may apply a post-processing filter, such as a simpler classifier or rule-based validator, to ensure that the generated text aligns with the threat category and does not contain misleading statements.

The server selects a warning prompt sentence from among the candidate outputs. The server evaluates each candidate based on metrics such as similarity to the core detection explanation, readability score, and compliance with maximum character length. The server chooses the candidate that best satisfies these metrics and forms the final warning prompt sentence. By quantifying and enforcing these constraints at the server level, the system consistently produces warning messages that are suitable for display on devices with limited screen real estate and that deliver the most critical information first.

The server then transmits the selected warning prompt sentence to the terminal as notification information. The server packages the warning prompt sentence with identifiers for the corresponding communication and threat category, and optionally with action codes indicating available user responses. The server forwards this package via a push notification service or an application-controlled channel, depending on whether the terminal application is in the foreground or background. The server optimizes transmission scheduling based on network conditions and configured delay constraints to maintain near real-time responsiveness while reducing redundant updates.

The terminal receives the notification information and presents the warning prompt sentence to the user. The terminal invokes the operating system's notification framework to display a banner, alert dialog, or in-application view that includes the warning prompt sentence and action buttons. For example, the terminal may display a prompt sentence such as “This email contains a suspicious login link that may be a phishing attempt. Do you really want to open this link?” or “The person you are speaking with is asking for one-time passwords and card details, which is often a sign of fraud. Are you sure you trust this caller?” The terminal can also present additional options that the user can select, such as “Show details,” “Delete message,” or “Block sender.”

The user interacts with the terminal by reading the warning prompt sentence and selecting one of the available actions. The user may choose not to open a suspicious link, to delete the communication, or to request further explanation. The user may additionally provide feedback such as marking a warning as helpful or incorrect. The user's choices and optional feedback are recorded by the terminal's application logic and converted into structured feedback data.

The terminal transmits the feedback data back to the server. The terminal attaches identifiers for the original communication and the associated notification to the feedback, and sends these via a secure communication channel. The server receives the feedback data and stores it in a feedback database, linking it to the original detection result and generated warning prompt sentence. The server uses this feedback to adjust model thresholds, select more effective prompt construction strategies, and refine abnormal pattern definitions.

The server updates the abnormal pattern determination process and the context generation process based on accumulated feedback. The server may, for example, lower the risk threshold for patterns frequently confirmed as dangerous or increase the threshold for patterns often labeled as false positives. The server may also adjust weightings for particular features in the anomaly detection model or update rules that identify suspicious elements. Within the generative AI model pipeline, the server may revise the textual templates or instruction segments used to form prompts so that the generative model focuses on elements that users have found most relevant. This feedback loop leads to incremental improvements in detection precision and user engagement, which in turn reduces unnecessary warnings and increases trust in the system.

The system provides technical effects in terms of computer performance and resource usage. By converting all communication content, including audio, into a unified text representation and storing it in a normalized data structure, the server reduces the need for separate processing pipelines. This design improves memory locality and allows batch processing of multiple messages using the same vectorized operations within the natural language processing library, which results in faster throughput and reduced CPU cache misses. The anomaly detection model uses compact feature representations and efficient neural network architectures, which reduce inference time per message and allow the server to process a larger volume of communication content with equivalent hardware resources.

The use of a generative AI model to synthesize prompt sentences from structured context information improves communication between the detection engine and the user interface in a way that traditional template-based systems cannot easily replicate. The generative AI model leverages fine-grained feature attributions from the abnormal pattern detection step to produce warnings that explicitly refer to the most suspicious elements. This focused content reduces the cognitive load on the user and shortens the average decision time, indirectly reducing the time that harmful communications remain unaddressed. The fact that the generative AI model is controlled through explicit context encoding and output filtering ensures that it functions as a deterministic component within constraints, rather than as an opaque or arbitrary text generator.

The server, by integrating the generative AI model with the anomaly detection engine and the feedback mechanism, performs a non-conventional sequence of operations that goes beyond automating manual review. The server does not merely replicate human reasoning, but instead applies numerical optimization, large-scale feature analysis, and structured context computation that would be infeasible for a human reviewer to perform in real time across high-volume data streams. This results in improved compute efficiency, reduced false positive and false negative rates, and better utilization of network bandwidth, because fewer redundant notifications and retransmissions are generated.

In alternative embodiments, the server may employ different machine learning architectures for anomaly detection, such as convolutional neural networks that treat sequences of tokens as structured grids, or recurrent neural networks that explicitly model temporal dependencies across sequential communications. The server may also employ different generative AI models, such as encoder-decoder architectures with attention mechanisms or smaller on-premise language models for environments with stricter data privacy requirements. The terminal may be implemented as a desktop client, a web browser application, or an embedded device, provided that the terminal can capture communication content and present notification information.

In another embodiment, the server prioritizes communication content based on threat likelihood and user importance metrics, and allocates more computational resources, such as GPU cycles, to high-priority communications. The server may adjust the complexity of the generative AI model decoding process according to risk level, using more exhaustive search methods for higher-risk communications and faster approximate methods for lower-risk communications. This adaptive control of computational effort further improves scalability and responsiveness.

Through these embodiments, the server, the terminal, and the user cooperate in a technically specific manner: the server normalizes and analyzes heterogeneous communication data, executes structured anomaly detection and context generation algorithms, uses a generative AI model to produce optimized prompt sentences, and continually refines its internal processes based on user feedback; the terminal acquires and presents data in formats compatible with the server's optimized pipelines; and the user contributes feedback that is used to adjust and improve the computational models. As a result, the system realizes improvements in processing speed, detection accuracy, communication efficiency, and resource utilization that go beyond conventional rule-based or static machine learning security systems.

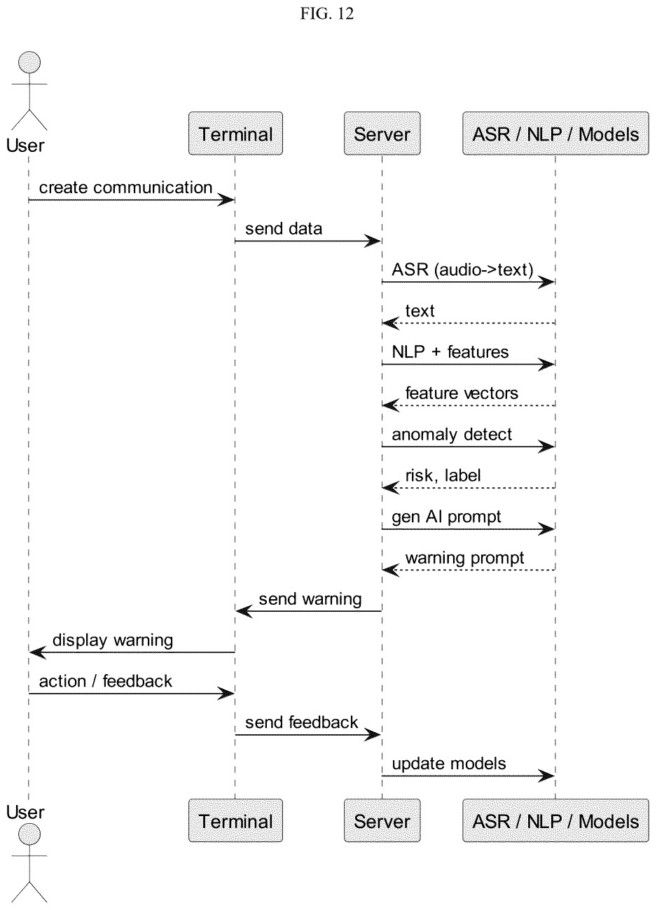

The following describes the processing flow using FIG. 12.

### Step 1

The terminal acquires communication content data from local applications.
The terminal receives, as input, raw communication data generated on the device, including email messages, chat messages, and audio streams from voice calls. The terminal calls application programming interfaces of mail, chat, or call applications to obtain message bodies, subjects, sender and recipient identifiers, timestamps, and channel identifiers, and calls an audio input interface to capture audio signals from a microphone. The terminal performs data processing by encoding text into a unified character encoding and encoding audio into a compressed or linear format. The terminal outputs a structured data object that includes text fields, audio fields, and associated metadata.

### Step 2

The terminal normalizes and packages the communication content data.
The terminal receives, as input, the structured data object containing raw text segments, audio segments, and metadata from Step 1. The terminal performs data processing by cleaning text (for example, removing control characters and normalizing whitespace), segmenting long messages, and truncating or chunking audio streams to a manageable duration. The terminal attaches device identifiers and session identifiers as additional metadata and serializes the entire structure into a transport format such as a JSON object. The terminal outputs a transmission-ready payload that includes normalized text, audio references or audio data, and complete metadata.

### Step 3

The terminal transmits the packaged payload to the server.
The terminal receives, as input, the transmission-ready payload from Step 2. The terminal uses a networking stack to establish a secure connection to the server, attaches authentication tokens, and sends the payload via a secure transport protocol. The terminal may perform retry logic, buffering unsent payloads in local storage when a transmission fails. The terminal outputs network packets carrying the payload to the server over the communication path.

### Step 4

The server receives and stores the communication content payload.
The server receives, as input, the network packets generated in Step 3 and reconstructs the payload at the application layer. The server parses the payload, verifies authentication data, and validates the structure of the incoming object. The server performs data processing by assigning an internal message identifier, associating the communication with a user identifier, and storing the normalized text, audio references or audio data, and metadata into a database or message queue. The server outputs a set of persistent records or queued messages ready for further analysis.

### Step 5

The server performs text normalization and feature extraction.
The server receives, as input, the text fields and metadata from the stored records generated in Step 4. The server uses a natural language processing library to tokenize the text into words and sentences, apply part-of-speech tagging, and perform named-entity recognition. The server computes derived features such as keyword presence, character n-gram statistics, URL patterns, and counts of indicative phrases. The server performs data processing by converting the text into a feature vector representation aligned to a vocabulary and feature schema. The server outputs normalized text and a set of numerical and categorical feature vectors associated with each communication.

### Step 6

The server converts audio information to text and integrates it into the feature space.
The server receives, as input, the audio data and associated metadata from the stored records in Step 4. The server sends the audio segments to an automatic speech recognition component configured with language and sampling parameters, and receives recognized text as output. The server performs data processing by cleaning the recognized text in the same manner as the original text and passing it through the same tokenization and feature extraction pipeline used in Step 5. The server merges these new feature vectors and recognized text segments with the existing records for the same communication. The server outputs enriched communication records that contain both original and recognized text along with unified feature vectors.

### Step 7

The server determines abnormal patterns and calculates a risk index.
The server receives, as input, the enriched communication records and feature vectors from Steps 5 and 6. The server applies rule-based logic to detect predefined abnormal patterns, such as suspicious domain structures, sequences of requests for credentials, or temporal patterns of repeated similar messages. The server also passes the feature vectors through a trained anomaly detection model, such as a neural network or an ensemble classifier, to compute probabilities for different threat categories. The server performs data processing by aggregating rule-based flags and model outputs into a numerical risk index and a set of detected threat labels. The server outputs a detection result that indicates whether an abnormal pattern exists, what category it belongs to, and what the corresponding risk index is.

### Step 8

The server generates structured context information for generative processing.
The server receives, as input, the detection result, the enriched communication records, and feature-level information from Step 7. The server selects the most relevant segments of the communication, such as suspicious text fragments or specific URLs, and collects metadata such as the communication channel, direction, and timestamp. The server performs data processing by constructing a context object that includes detection flags, threat category, numerical risk index, triggered rules, and representative text excerpts. The server may also mask or redact sensitive elements such as full account numbers. The server outputs a structured context object that summarizes the abnormal pattern and its salient features.

### Step 9

The server constructs an input prompt for the generative AI model.
The server receives, as input, the structured context object from Step 8. The server converts the context into a textual description by embedding it into an instruction template, for example: system instructions, analysis summary, and quoted suspicious excerpts. The server performs data processing by concatenating fixed instruction segments with variable context fields and enforcing limits on total token length, truncating less important portions when necessary. The server outputs a formatted input sequence suitable for ingestion by the generative AI model.

### Step 10

The server invokes the generative AI model to create candidate prompt sentences.
The server receives, as input, the formatted input sequence from Step 9. The server feeds this sequence into a generative AI model, such as a transformer-based language model, configured with parameters like maximum output length, decoding strategy, and temperature. The server triggers the model to perform forward passes on the input sequence and iteratively generate output tokens that form candidate sentences. The server performs data processing by generating one or more complete candidate prompt sentences that contain warning content, recommended actions, and confirmation items. The server outputs a set of candidate prompt sentences associated with the context.

### Step 11

The server evaluates and selects a final warning prompt sentence.
The server receives, as input, the set of candidate prompt sentences from Step 10 and the original context object from Step 8. The server computes evaluation metrics such as sentence length, presence of required elements, readability estimates, and alignment between key threat elements and the text of each candidate. The server performs data processing by filtering out candidates that violate length or style constraints and ranking the remaining candidates according to a scoring function. The server selects the highest-scoring candidate as the final warning prompt sentence. The server outputs the selected warning prompt sentence and its associated metadata.

### Step 12

The server transmits notification information containing the warning prompt sentence to the terminal.
The server receives, as input, the selected warning prompt sentence and metadata from Step 11. The server constructs a notification payload including the text of the warning prompt sentence, identifiers for the underlying communication, and optional suggested user actions. The server performs data processing by encoding this payload into a format required by a notification delivery service and scheduling transmission according to timing constraints or user-specified display conditions. The server outputs outgoing notification messages sent over the communication path to the terminal.

### Step 13

The terminal receives and displays the warning prompt sentence to the user.
The terminal receives, as input, the notification messages sent in Step 12. The terminal decodes the payload and extracts the warning prompt sentence and associated identifiers. The terminal performs data processing by mapping the identifiers to local representations of the underlying communication, deciding the appropriate display method (for example, banner, dialog, or in-app view), and rendering user interface elements with the warning prompt sentence and interactive controls. The terminal outputs a visual display on the screen, presenting the warning prompt sentence to the user along with selectable options.

### Step 14

The user reviews the warning prompt sentence and selects an action.
The user receives, as input, the displayed warning prompt sentence on the terminal. The user interprets the warning content and the recommended actions, and interacts with the terminal by tapping or clicking interface elements such as “Open anyway,” “Delete,” “Block sender,” or “Show details.” The user may also input explicit feedback, such as indicating that the warning was incorrect. The user outputs a chosen action and optional feedback through the terminal's input mechanisms.

### Step 15

The terminal records the user's action and sends feedback to the server.
The terminal receives, as input, the user's selected action and any typed or selected feedback from Step 14. The terminal performs data processing by associating the action and feedback with the identifiers of the notification and the underlying communication, and by constructing a feedback object containing this association. The terminal serializes the feedback object into a transport format and sends it to the server over a secure communication channel. The terminal outputs network packets containing structured feedback data addressed to the server.

### Step 16

The server updates detection and generation processes based on user feedback.
The server receives, as input, the structured feedback data from Step 15. The server correlates the feedback with the original detection result and the generated warning prompt sentence using stored identifiers. The server performs data processing by logging the feedback into a training or calibration dataset, adjusting model thresholds or rule weights, and optionally scheduling retraining or recalibration of the anomaly detection model and the generative prompt construction templates. The server may update parameters that control how context information is selected and how instructions to the generative AI model are formed. The server outputs updated model parameters, rule sets, and configuration data that influence subsequent abnormal pattern determinations and prompt sentence generation.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional content monitoring systems that analyze user communications for inappropriate or offensive expressions typically rely on fixed rule sets, keyword lists, or simple pattern matching. Such systems suffer from several technical limitations. First, they often generate a high rate of false positives and false negatives because they do not adequately use syntactic and contextual information derived from the text, such as part-of-speech relationships and dependency structures. Second, these systems are generally not designed to integrate structured analysis results with generative artificial intelligence models in a systematic way, and therefore cannot dynamically generate context-aware explanations or alternative expressions that are tailored to the specific content and user. Third, conventional architectures usually do not provide a unified control mechanism that links low-level text analysis, prompt generation for generative models, and notification delivery policies, and thus struggle to provide timely user feedback while respecting user preferences regarding notification timing, frequency, and severity thresholds.

As a result, existing systems cannot effectively support real-time, personalized feedback on inappropriate expressions in user communications, and they do not exploit available computing resources, natural language processing pipelines, and generative AI models in a coordinated manner. This leads to an inefficient use of processing capability, suboptimal user experience, and limited ability to improve the quality and politeness of communications. There is therefore a need for an improved computer-implemented technique that integrates structured natural language processing, prompt sentence generation for a generative AI model, and adaptive notification control to provide more accurate, context-sensitive detection of inappropriate expressions and more effective user guidance.

The specific processing by the specific processing unit 290 of the data processing device 12 in Example 2 is realized by the following means.

The present invention provides a server comprising a processor configured to acquire communication content from a user terminal through a communication network, store the communication content as text information in a storage device, perform natural language processing on the text information including at least word segmentation and part-of-speech tagging to generate analysis result data, identify one or more inappropriate expressions by comparing tokens in the text information with a predefined judgment vocabulary set and associating attribute information with the identified inappropriate expressions, generate, based on the analysis result data and the text information, a prompt sentence for input to a generative AI model, input the prompt sentence to the generative AI model and obtain response information including at least one of explanation information and alternative expression candidates for the inappropriate expressions, generate notification information including at least the text information containing the inappropriate expressions, the explanation information, and the alternative expression candidates, and transmit the notification information to the user terminal in accordance with user setting information that specifies at least one of a transmission time, a transmission frequency, and a severity threshold for the inappropriate expressions. This enables an improved computer-implemented content moderation technique that integrates structured natural language processing and generative AI-based prompt-response processing, thereby providing context-aware detection of inappropriate expressions and adaptive, user-specific notification delivery while efficiently utilizing computing resources to enhance responsiveness and user experience.

The term “communication content” refers to information representing a user's message or interaction, including at least natural language text generated or selected by the user and transmitted or to be transmitted through a communication network.

The term “user terminal” refers to an information processing apparatus operated by a user, such as a client device that sends and receives communication content and notification information through a communication network.

The term “communication network” refers to an infrastructure that enables data transmission between the server and one or more user terminals, including at least wired or wireless packet-based networks.

The term “text information” refers to data representing communication content in a character-based or token-based format suitable for natural language processing and storage in a memory or storage device.

The term “natural language processing” refers to computer-implemented processing that analyzes text information using algorithms configured to handle human languages, including at least word segmentation and part-of-speech tagging.

The term “word segmentation” refers to processing that divides text information into units such as tokens or words, which can be individually analyzed for further linguistic processing.

The term “part-of-speech tagging” refers to processing that assigns grammatical categories, such as nouns, verbs, adjectives, or adverbs, to tokens in the text information.

The term “analysis result data” refers to data generated by the natural language processing, including at least token information, part-of-speech information, and attribute information relating to detected inappropriate expressions.

The term “inappropriate expressions” refers to words, phrases, or other textual elements that are determined to be insulting, offensive, or otherwise undesirable according to a predefined criterion.

The term “judgment vocabulary set” refers to a collection of lexical entries or patterns used as reference data to determine whether tokens or token sequences in the text information correspond to inappropriate expressions.

The term “attribute information” refers to metadata associated with an identified inappropriate expression, including at least positional information, type information, and severity information.

The term “prompt sentence” refers to text that is generated for input to a generative AI model, the text including at least an instruction portion and a portion derived from the text information and the analysis result data.

The term “generative AI model” refers to a machine learning model configured to generate output content, such as natural language text, given an input sequence including a prompt sentence.

The term “response information” refers to data output by the generative AI model in response to the prompt sentence, including at least explanation information and/or alternative expression candidates.

The term “explanation information” refers to information describing reasons why an expression is determined to be inappropriate or how it may be perceived, based on analysis and/or generative AI output.

The term “alternative expression candidates” refers to one or more suggested textual formulations that can replace a detected inappropriate expression in order to reduce offensiveness or improve politeness.

The term “notification information” refers to data generated for presentation to the user, including at least original text information containing inappropriate expressions, explanation information, and alternative expression candidates.

The term “user setting information” refers to configuration data associated with a user, including at least parameters that specify conditions for transmission of notification information, such as timing, frequency, and severity thresholds.

The term “severity threshold” refers to a value or level that is used to determine whether detected inappropriate expressions are sufficiently serious to trigger generation or transmission of notification information.

The term “transmission timing” refers to a point in time or time condition, such as real time or scheduled time, at which notification information is transmitted from the server to the user terminal.

The term “transmission frequency” refers to a rate or interval at which notification information is transmitted, such as per message, periodically, or in aggregated form over a specified duration.

In one embodiment, a server executes a program that implements the claimed system by using general-purpose computing hardware and specialized software components. The server includes at least one central processing unit (CPU), a main memory, a non-volatile storage device, a network interface controller, and an operating system such as a UNIX-based or Linux-based operating system. The server further executes an application server framework implemented, for example, by a web application framework and a background task scheduler. The server communicates with at least one terminal via a communication network such as the Internet, and the terminal comprises a processor, a memory, a display device, and a communication interface, and executes a client application that exchanges data with the server.

The server stores program modules including at least a communication acquisition module, a natural language processing module, an inappropriate expression detection module, a prompt generation module, a generative AI interaction module, a notification generation module, and a user setting management module. The server stores these modules as executable instructions in the storage device, and loads corresponding instructions into the main memory when executing the modules.

The server uses the communication acquisition module to receive communication content from the terminal or from external communication platforms. The server receives, via the network interface controller, text data encapsulated in structured messages such as a request containing fields including a user identifier, a message identifier, a channel identifier, a timestamp, and message text. The server stores the received text data in a structured data repository such as a relational database, in which the server defines tables including a message table, an analysis result table, and a user setting table. Each record of the message table contains at least a primary key, a foreign key linked to a user record, and a text column storing character data encoded in a character encoding scheme such as UTF-8.

The server uses the natural language processing module to perform text analysis on the stored text information. The server loads linguistic resources such as tokenization models, part-of-speech taggers, and syntactic parsing models from a model storage area. In one embodiment, the server uses a word segmentation algorithm that applies a rule-based and statistical tokenizer to separate an input character sequence into tokens by considering whitespace, punctuation, and learned token boundaries. The server then uses a part-of-speech tagging algorithm that applies a sequence labeling model, such as a hidden Markov model or a neural sequence tagger, which assigns grammatical category labels to each token based on contextual features including preceding and following tokens, token shapes, and lexical properties.

The server optionally uses a syntactic parsing component that implements a dependency parser or a constituency parser to determine relationships among tokens. The server represents the parsed output as an internal data structure such as a directed graph, where nodes correspond to tokens and edges represent syntactic dependencies. By storing the dependency structure in memory, the server is able to determine whether an adjective or insulting expression directly modifies a second-person pronoun or a named entity referring to a person, which is used as part of a context-aware detection process.

The server uses the inappropriate expression detection module to identify tokens or token sequences that correspond to inappropriate expressions. The server stores a judgment vocabulary set in the database or in a dictionary file, where each entry comprises a lexical form, optional morphological variants, semantic categories, and severity scores. The server normalizes each token by converting to a canonical form such as lowercase and applying stemming or lemmatization, and then compares the normalized tokens with entries in the judgment vocabulary set. When the server finds a match, the server records attribute information including a token index, a character offset, a severity level, and a detected category such as “insult”, “profanity”, or “discriminatory term”.

The server further refines detection results by using the syntactic analysis results. For example, the server determines that an adjective such as “incompetent” is more severe when it is predicated directly on a second-person pronoun, as in “You are really incompetent,” than when it is used in an abstract context. The server encodes such rules in a rule set that operates on dependency patterns. Each rule has a condition part, which checks for a specific dependency pattern, and an action part, which modifies severity or flags an expression as contextually inappropriate. The server represents the analysis result data as a structured object containing lists of detected expressions, associated tokens, syntactic relations, and attribute information, and stores references to this object in the analysis result table.

The server uses the prompt generation module to construct a prompt sentence for a generative AI model. The server reads the analysis result data and the original text information, and embeds them into a prompt template that defines an instruction segment and a content segment. In one implementation, the server generates a prompt sentence such as:
“From the following text, detect any non-delicate or inappropriate expressions and explain why they may be problematic. Output the result as natural language. Text: ‘You are really incompetent and useless at this job.’”

In another implementation, the server generates a prompt sentence such as:
“Please list all non-delicate expressions in the following sentence and suggest more polite alternatives. Sentence: ‘You are really incompetent.’”

The server constructs prompt sentences by concatenating pre-defined instruction strings with the user text and with summary descriptions of the analysis results, such as detected tokens and severity levels. The server uses specific delimiters and formatting rules to ensure that the generative AI model can reliably interpret the different components of the prompt.

The server uses the generative AI interaction module to communicate with a generative AI model. In one embodiment, the server accesses a language generation model hosted on an external model server via an application programming interface. The generative AI model comprises a multi-layer neural network architecture such as a transformer-based model with self-attention layers, feed-forward layers, and an output softmax layer over a vocabulary. The server stores model parameters, including weight matrices and bias vectors for each layer, on a model storage device of the model server, and the model server executes inference by applying matrix multiplications and non-linear activation functions to transform an input token sequence, representing the prompt sentence, into an output token sequence.

The server sends the prompt sentence to the generative AI model through a network connection, where the server encodes the prompt as a sequence of token identifiers, and the model computes contextual embeddings for each token by using attention mechanisms and positional encodings. The model then calculates output probability distributions for next tokens and samples or selects tokens according to a decoding strategy such as greedy decoding or beam search. The model applies a loss function and weight update only during a training phase; during deployment for this system, the model performs forward propagation only.

Although the training of the generative AI model can be performed offline, the structure of the model and its training method contribute to the technical effects of the system. For example, the model can be trained using a large corpus of conversational data, with objective functions that include cross-entropy loss and alignment losses for instruction-following tasks. The training algorithm uses gradient-based optimization such as stochastic gradient descent with adaptive learning rate methods, and updates parameters of attention layers and feed-forward layers to minimize the loss. The trained model thereby learns to generate context-aware, grammatically correct, and socially aware explanations and suggestions that cannot be feasibly produced by simple rule-based systems.

The server parses the output token sequence generated by the generative AI model and reconstructs it into natural language response information. The server then extracts, from the response information, explanation information describing why particular expressions are inappropriate and alternative expression candidates that are more polite or less offensive. The server associates this response information with the analysis result data to form enriched analysis records.

The server uses the notification generation module to produce notification information for the terminal. The server composes a notification message by combining the original text information, the list of detected inappropriate expressions, explanation information for each expression, and zero or more alternative expression candidates. The server may structure this information internally as a data object with fields including a message identifier, a list of flagged spans, and textual explanation segments, and then serialize the object for transport to the terminal. The server further uses the user setting management module to read user setting information from the database, where settings include notification mode (real-time or batch), notification frequency, and minimum severity threshold.

The server uses these settings to control transmission conditions. For example, if the user setting specifies real-time notification and a low severity threshold, the server transmits a notification as soon as an inappropriate expression is detected and processed by the generative AI model. If the user setting specifies daily summary mode and a higher severity threshold, the server accumulates notifications for a time period and transmits only those messages whose severity exceeds the threshold at a scheduled time. By implementing this scheduling and filtering within the server, the system reduces unnecessary network transmissions and reduces processing load on both server and terminal, which improves communication efficiency and power consumption characteristics.

The terminal uses a client application to display notification information to the user. The terminal receives the notification information via a push mechanism or by polling the server, and stores the notification in its local memory. The terminal converts the notification into one or more screen views that show highlighted inappropriate expressions in the context of the original text, together with the explanation information and alternative expression candidates. The user can review the notification on the display and may select an alternative expression to replace the original expression in subsequent communications.

The server achieves technical improvements over conventional systems in several ways. First, by combining structured natural language processing, including tokenization, part-of-speech tagging, and dependency parsing, with a judgment vocabulary set and context-sensitive rule evaluation, the server reduces false positives and false negatives compared to simple keyword matching. This yields a measurable improvement in detection accuracy and decreases error rates.

Second, by generating prompt sentences that include machine-readable summaries of analysis results and by using a transformer-based generative AI model, the server obtains explanations and alternative suggestions that are tightly coupled to the internal representation of the text and its context. This integration allows the system to offload complex natural language generation tasks to the model while keeping deterministic control over what information is provided to the model. The combination of deterministic analysis and probabilistic generation leads to a more efficient use of the generative model, reducing the length and number of prompts required, and therefore reducing compute time and network bandwidth for model interaction.

Third, by storing analysis results and user settings in structured data formats and by controlling notification transmission according to severity thresholds and timing settings, the server optimizes resource usage. For example, the server can group multiple notifications into a single aggregated message, reducing communication overhead, or can skip low-severity notifications during peak hours to balance processing load. These methods improve processing throughput, reduce latency for high-priority notifications, and reduce memory and storage overhead for low-priority events.

Fourth, by employing an internal data flow where each module operates on well-defined data structures, the server improves data management and processing efficiency. Token sequences, POS tags, dependency graphs, and vocabulary matches are stored in compact representations that minimize redundancy. This facilitates faster lookups and comparisons, and reduces the amount of data transferred between modules in memory. The server uses indices and caching strategies in the database to quickly retrieve historical analysis results and user settings, thereby further enhancing performance.

The server also implements rules and algorithms that are not trivially equivalent to human review. For example, the server uses numerical severity scores combined with contextual modifiers derived from dependency structures and model-generated metadata. The server may increase severity by a fixed factor when an insulting term directly targets a personal pronoun, or decrease severity when a term appears in a quoted or self-referential context. These operations represent a non-conventional combination of symbolic rule-based processing with statistical language models, which provides predictable and tunable behavior that is difficult for human reviewers to replicate consistently.

Alternative embodiments can vary individual components while maintaining the overall technical concept. In one embodiment, the server uses a different natural language processing toolkit or a different language model architecture, such as a recurrent neural network-based model or a convolutional sequence model, instead of a transformer. In another embodiment, the server maintains the judgment vocabulary set as a hierarchical structure in which entries are grouped by semantic category and are associated with different severity ranges. The server can also adapt the judgment vocabulary set dynamically by logging model outputs and user feedback, and then retraining or updating the vocabulary entries based on frequency and context patterns.

The server can further implement hardware-level optimizations. For example, the server can offload matrix multiplication operations required for the generative AI model to specialized hardware such as a graphics processing unit or a tensor processing unit, which increases inference throughput and allows real-time interaction with the model even under high load conditions. The server can also allocate and reuse memory buffers for token sequences and attention matrices, reducing memory fragmentation and improving cache locality.

By designing the system as described above, the server, the terminal, and the user cooperate to achieve not only functional advantages in terms of inappropriate expression awareness, but also explicit improvements in computer technology. The system improves the speed and accuracy of text analysis, reduces communication overhead between modules and devices, and enables scalable integration of complex generative AI models with deterministic rule-based processing. These improvements are realized by specific data structures, algorithms, and control flows implemented on a concrete computing architecture, and therefore are not limited to an abstract idea but provide a technical solution in the field of computer-implemented text analysis and user communication support.

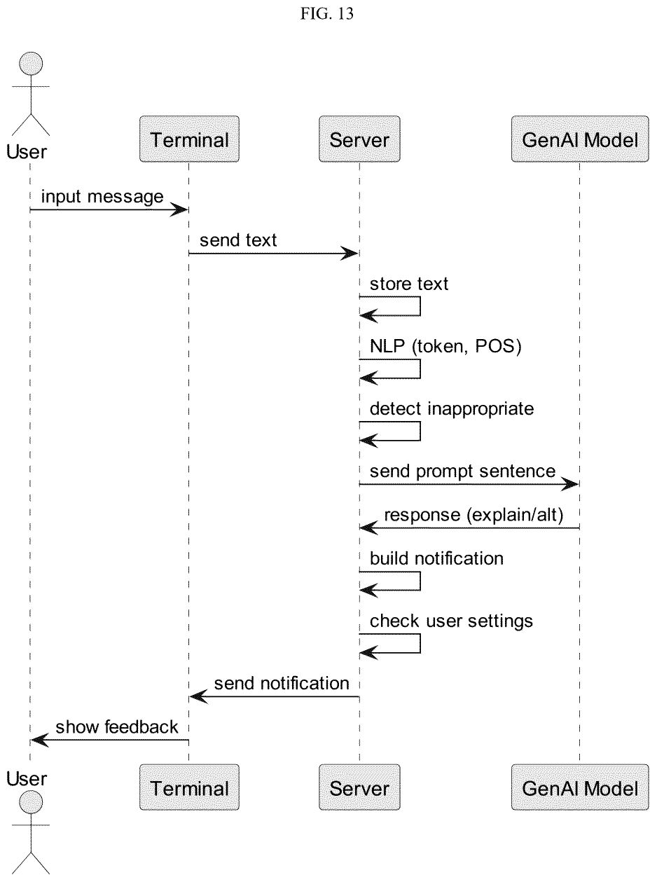

The following describes the processing flow using FIG. 13.

### Step 1

Server receives communication content from terminal and stores it as text information.
Server accepts, as input, a structured request from the terminal containing at least a user identifier, a message identifier, a timestamp, and a text field representing communication content. Server parses the request at an application layer, validates the format and encoding of the text field, and converts the text into a normalized character encoding such as UTF-8. Server then performs a data insertion operation into a message table of a database, writing the user identifier, message identifier, timestamp, and normalized text as a new record. The output of this step is a stored text record associated with a unique internal message ID in the database.

### Step 2

Server retrieves unanalyzed text information and prepares it for natural language processing.
Server takes, as input, a query condition specifying that analysis has not yet been performed (for example, a flag value or a null analysis reference). Server executes a database query to select one or more message records that satisfy the condition and reads the corresponding text fields and message IDs into main memory. Server concatenates or groups the selected text strings into an internal list structure, and initializes data containers for storing tokens, part-of-speech tags, and analysis metadata. The output of this step is an in-memory batch of text items each associated with its message ID and ready for linguistic processing.

### Step 3

Server performs tokenization on the text information.
Server receives, as input, the batch of raw text strings and associated message IDs from Step 2. Server executes a word segmentation algorithm that scans each character sequence, identifies token boundaries based on whitespace, punctuation, and learned statistical patterns, and segments the text into ordered lists of tokens. For each message, server constructs a token list and records token indices and character offset positions. Server stores these token lists in an internal data structure, such as an array of token objects, each token object including text, position, and message ID references. The output of this step is a set of token lists, one per message, with positional information attached.

### Step 4

Server applies part-of-speech tagging to the tokenized text.
Server accepts, as input, the token lists generated in Step 3. Server loads a part-of-speech tagging model, such as a statistical sequence tagger or a neural sequence labeler, into memory. Server then feeds each token sequence to the tagger, which computes grammatical category labels for each token using contextual features (e.g., surrounding tokens, token shape, and learned parameters). Server attaches the resulting part-of-speech tag to each token in the corresponding token list, and updates the internal data structure to include both token text and tag. The output of this step is a set of annotated token sequences containing, for each token, its text, position, and part-of-speech tag.

### Step 5

Server optionally performs syntactic parsing to derive dependency or constituency structure.
Server takes, as input, the annotated token sequences from Step 4. Server runs a parsing algorithm that computes syntactic relations among tokens by applying trained parsing models. For each message, server builds a syntactic tree or dependency graph, where each node corresponds to a token and each edge corresponds to a grammatical relationship such as subject, object, or modifier. Server stores this structure as a graph data object indexed by message ID, with adjacency lists or parent-child pointers representing the relationships. The output of this step is a set of syntactic structures that encode the grammatical context of each token sequence.

### Step 6

Server detects inappropriate expressions by comparing tokens against a judgment vocabulary set.
Server receives, as input, the annotated token sequences (and optionally the syntactic structures) from Steps 4 and 5, and a stored judgment vocabulary set that includes lexical entries and severity scores. Server normalizes each token by applying operations such as lowercasing, stemming, or lemmatization. Server then performs a lookup for each normalized token in the judgment vocabulary set, using data structures such as hash tables for efficient matching. When server finds a match, server records a detection entry including the message ID, token index, character offsets, matched lexical entry, and base severity. The output of this step is a preliminary list of detected inappropriate expressions for each message, without yet considering full contextual adjustments.

### Step 7

Server adjusts detection results based on syntactic and contextual information.
Server accepts, as input, the preliminary detection list from Step 6 and the syntactic structures from Step 5. Server applies context-aware rules that inspect patterns in the dependency graph or syntactic tree, such as a predicate adjective directly modifying a second-person pronoun, or an insulting term attached to a named entity. For each detected expression, server evaluates rule conditions and, if matched, modifies the severity score, adds contextual labels (e.g., “direct insult to user”), or discards detections in non-offensive contexts (e.g., quoted or hypothetical usage). Server performs arithmetic operations such as multiplying severity by a fixed factor or adding an offset, and updates the attribute information for each detected expression accordingly. The output of this step is refined analysis result data containing context-adjusted inappropriate expression entries with detailed attributes.

### Step 8

Server aggregates analysis result data into a structured representation.
Server takes, as input, the refined detection entries from Step 7 and the original message metadata from Step 1. Server groups detection entries by message ID and constructs, for each message, an analysis result object that includes the original text, the list of detected expressions, positions, categories, and final severity scores. Server stores a reference to this analysis result object in an analysis result table of the database, linking it to the corresponding message record. The output of this step is a set of persistent analysis result records that can be accessed for subsequent prompt generation and notification.

### Step 9

Server generates a prompt sentence for a generative AI model based on analysis results and text information.
Server accepts, as input, the analysis result data and the original text for one or more messages from Step 8. Server selects or constructs an instruction template appropriate to the type of analysis required (e.g., explanation-only or explanation-plus-alternatives). Server then embeds the original text and a summary of the detected expressions (such as their spans and severity) into the template by string concatenation and formatting operations. For example, server may generate:
“From the following text, detect any non-delicate or inappropriate expressions and explain why they may be problematic. Output the result as natural language. Text: ‘You are really incompetent and useless at this job.’”
or
“Please list all non-delicate expressions in the following sentence and suggest more polite alternatives. Sentence: ‘You are really incompetent.’”
Server ensures that the prompt sentence is a coherent natural language instruction that encodes key analysis data in a compact form. The output of this step is at least one prompt sentence string ready for input to a generative AI model.

### Step 10

Server sends the prompt sentence to the generative AI model and obtains response information.
Server takes, as input, the prompt sentence from Step 9 and a configuration specifying model parameters such as maximum output length and decoding strategy. Server encodes the prompt sentence into a sequence of token identifiers using a tokenizer associated with the generative AI model. Server then transmits the token sequence to the model, which applies its neural network layers, including attention and feed-forward computations, to generate output token probabilities and selects output tokens according to the specified decoding method. Server receives the generated token sequence from the model and decodes it back into natural language text. The output of this step is response information in the form of one or more natural language strings that include at least explanation information and/or alternative expression candidates.

### Step 11

Server parses the response information and extracts structured explanation and alternative candidates.
Server accepts, as input, the natural language response strings from Step 10. Server applies text processing operations, which may include pattern matching, simple tokenization, or delimiter-based splitting, to identify segments corresponding to explanations and segments corresponding to alternative expressions. If the prompt sentence requested a specific output format, server uses predefined markers or keywords to locate and separate relevant parts. Server then builds a structured response object containing mappings from each detected inappropriate expression to its explanation text and any proposed alternative expressions. The output of this step is a structured representation of explanation information and alternative expression candidates associated with each message.

### Step 12

Server combines analysis result data and structured response information into notification content.
Server takes, as input, the analysis result objects from Step 8 and the structured response objects from Step 11. Server aligns these data by message ID and detected expression indices, and merges fields such as positions, categories, severity scores, explanations, and alternatives into a unified notification data object for each message. Server may additionally compute summary indicators, such as the highest severity in the message, or count of inappropriate expressions, by aggregating values across entries. The output of this step is a set of notification data objects that fully describe the original text, detected expressions, associated explanations, and alternative wording options.

### Step 13

Server determines whether and when to send notifications based on user setting information.
Server accepts, as input, the notification data objects from Step 12 and user setting information retrieved from a user setting table. User setting information includes, for example, a notification mode (real-time or batch), a minimum severity threshold, and preferred notification windows. Server compares the severity values in each notification data object with the user's minimum threshold and applies logical conditions to decide whether the notification should be sent or suppressed. If batch mode is configured, server schedules the notification data object for later aggregation rather than immediate transmission. The output of this step is a subset of notification data objects marked for transmission along with associated timing information (immediate or scheduled).

### Step 14

Server transmits notification information to terminal according to determined timing.
Server takes, as input, the transmission-marked notification data objects and their timing information from Step 13. For notifications requiring immediate delivery, server formats the notification data into a payload compatible with a push notification or an application-level message, including fields such as title, body text, and structured details. For scheduled notifications, server aggregates multiple notification data objects into a single summarized payload when the scheduled time is reached. Server then sends the payload to the terminal via a communication channel, such as a push notification service or an HTTPS response to a polling request. The output of this step is transmitted notification information that arrives at the terminal.

### Step 15

Terminal receives notification information and displays feedback to user.
Terminal accepts, as input, the notification payload transmitted by the server in Step 14. Terminal uses its operating system notification framework and client application to parse the payload, extract text fields, and store associated metadata locally. Terminal renders a user interface that shows the original message text with highlighted inappropriate expressions, and displays corresponding explanations and alternative expression candidates retrieved from the payload. Terminal may allow user interaction, such as tapping an expression to see more details or selecting an alternative expression to copy. The output of this step is a visual presentation of feedback on the terminal display that enables the user to understand and modify communication behavior.

### Step 16

User reviews feedback and optionally adjusts future communication.
User takes, as input, the feedback displayed by the terminal in Step 15. User reads the highlighted expressions, the explanations, and the suggested alternatives, and then mentally evaluates whether to revise wording in future messages or send a follow-up clarification. User may interact with the client application to modify personal settings, such as raising the severity threshold or changing the notification frequency, which the terminal then sends back to the server as updated user setting information. The output of this step is an adjusted user behavior or updated configuration, which in turn influences subsequent processing by the server.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

In network-based communication environments, such as messaging platforms, collaboration tools, and application-layer services, conventional content moderation and anomaly detection are typically implemented as static rule engines or passive classifiers. These conventional techniques suffer from several technical limitations.

First, existing moderation pipelines generally operate as one-way filters that label text as inappropriate or abnormal but do not dynamically generate context-specific guidance or alternative expressions. As a result, the system cannot flexibly adapt its output to different communication contexts, user profiles, or evolving language usage. This limits the system's ability to provide actionable, fine-grained feedback at the time of message composition, and forces developers to hard-code response patterns, increasing maintenance cost and reducing scalability.

Second, conventional systems usually decouple content analysis from user state analysis. They treat each message as an isolated text input, without robustly incorporating emotion signals or other user-state information into the control flow of the moderation pipeline. Consequently, prior systems often deliver warnings at suboptimal times or with inappropriate tone. For example, a warning can be pushed immediately to a user who is already stressed or angry, which may increase user frustration and cause the user to disengage from the system. From a computer-technical perspective, this absence of a feedback loop between emotional signals and notification control leads to inefficient use of computation and network resources, because notifications are generated and transmitted without prioritization or scheduling that reflect user receptiveness.

Third, conventional anomaly detection systems for communication streams mainly focus on static pattern matching for security risks, such as phishing or data leakage, and often provide only generic alerts. These alerts lack machine-generated explanations and concrete, user-adaptive countermeasures. The backend processing units must therefore be configured with large sets of handcrafted messages and templates, which must be manually updated when new attack patterns arise. This rigid design constrains how the server-side processor can exploit advanced generative models and prompt-based conditioning to flexibly generate explanations and recommendations at runtime, and it fails to fully leverage modern generative AI models to improve the quality and specificity of warnings.

Fourth, known systems that use machine learning models often fix the model input interface to raw text or simple feature vectors, without employing an explicit, structured “prompt sentence” layer that can be algorithmically constructed and dynamically varied according to detected patterns and system state. Without such a prompt abstraction, it is difficult to reconfigure the inference tasks of a generative AI model on the fly (for example, switching between classification, explanation, and rewriting tasks) within a unified server architecture. This reduces extensibility and makes it harder to systematically orchestrate multiple AI behaviors in a single inference pipeline.

Accordingly, there is a need for a computer-implemented system that (i) acquires communication content and analyzes it against both inappropriate-expression patterns and abnormal security-related patterns, (ii) automatically constructs prompt sentences as structured inputs to a generative AI model, (iii) uses the generative AI model to generate not only detection results but also detailed explanations and candidate rewrites, and (iv) dynamically adjusts notification timing and style based on emotion-related state information, thereby improving the overall efficiency, adaptability, and technical performance of the moderation and anomaly-detection pipeline executed by the server processor.

The specific processing by the specific processing unit 290 of the data processing device 12 in Application Example 2 is realized by the following means.

The present invention provides a server comprising a processor configured to acquire communication content from a user apparatus via a communication network, to analyze the acquired communication content using a language processing technique and to compare the analyzed communication content with predetermined patterns including at least an inappropriate expression and an abnormal pattern so as to generate evaluation information of the communication content, to determine, on the basis of the evaluation information, whether the communication content includes the inappropriate expression or the abnormal pattern, to generate a prompt sentence, on the basis of the communication content and the evaluation information, for input to a generative artificial intelligence model, to input the prompt sentence to the generative artificial intelligence model and to obtain, from the generative artificial intelligence model, response information including a content of the inappropriate expression or the abnormal pattern and a recommended response for a user, to generate user notification information including warning information or expression candidate information, on the basis of the response information, to adjust a notification timing or a notification expression of the user notification information, on the basis of emotional state information acquired from an emotion estimation apparatus or an emotion analysis module, and to transmit the user notification information to the user apparatus. This enables the server-side processing pipeline to dynamically construct and supply structured prompt sentences to a generative AI model, to obtain context-specific explanations and alternative expressions in response to detected inappropriate or abnormal patterns, and to control the generation, scheduling, and style of user notifications based on emotion-aware state information, thereby improving the technical functioning of the content moderation and anomaly-detection system in terms of adaptability, resource utilization, and user-response effectiveness.

The term “communication content” refers to digital information representing messages or utterances generated or received by a user apparatus, including at least text data obtained from chat, email, social communication, or transcribed speech, which is processed by the server for analysis and notification.

The term “user apparatus” refers to an information processing device operated by a user, such as a terminal, client device, or wearable device, that is configured to send communication content to the server and to receive user notification information from the server.

The term “communication network” refers to a wired or wireless data transmission infrastructure, including at least packet-based networks, over which the server and one or more user apparatuses exchange communication content and notification information.

The term “language processing technique” refers to a computational procedure executed by the processor to analyze text data, including at least tokenization, syntactic or semantic analysis, and comparison with predetermined patterns.

The term “predetermined pattern” refers to a rule or data structure representing a known linguistic or behavioral pattern, including at least an inappropriate expression pattern or an abnormal pattern, that is stored in advance and used as a reference for comparing with communication content.

The term “inappropriate expression” refers to a linguistic expression contained in the communication content that is determined, based on predetermined criteria, to be offensive, rude, insensitive, or otherwise unsuitable for a target communication environment.

The term “abnormal pattern” refers to a pattern in the communication content that deviates from expected or normal usage, including at least suspicious security-related behavior, data leakage indications, or other anomalous communication forms defined in advance.

The term “evaluation information” refers to metadata or internal data generated by the processor that characterizes the communication content, including at least a result of comparison with predetermined patterns and a determination as to whether inappropriate expressions or abnormal patterns are present.

The term “generative artificial intelligence model” refers to a machine learning model configured to generate output data such as natural language text in response to input data, including at least a model trained to follow prompt sentences and to output explanations, recommendations, or rewritten expressions.

The term “prompt sentence” refers to a structured input text generated by the processor for the generative artificial intelligence model, the structured input text including at least a part of the communication content and one or more instructions specifying a task to be executed by the generative artificial intelligence model.

The term “response information” refers to output data obtained from the generative artificial intelligence model in response to the prompt sentence, the output data including at least information describing contents of inappropriate expressions or abnormal patterns and recommended responses or alternative expressions for a user.

The term “warning information” refers to information included in user notification information that notifies the user that the communication content contains an inappropriate expression or an abnormal pattern and may include an explanation of a risk or problem.

The term “expression candidate information” refers to information including one or more alternative linguistic expressions generated for rewriting the communication content into a form that does not correspond to an inappropriate expression or an abnormal pattern.

The term “user notification information” refers to data generated by the processor and transmitted to the user apparatus, the data including at least warning information and/or expression candidate information to be presented to the user.

The term “emotional state information” refers to data indicating an estimated emotional condition of a user, such as stress, anger, calmness, or positivity, obtained from an emotion estimation apparatus or an emotion analysis module on the basis of communication content, sensor data, or both.

The term “emotion estimation apparatus” refers to a hardware or software component configured to acquire signals related to a user's state, including at least textual, audio, or physiological signals, and to output emotional state information based on analysis of the signals.

The term “emotion analysis module” refers to a software component executed by the processor or by another computing resource, which analyzes communication content, sensor data, or both, using a computational model to generate emotional state information.

The term “notification timing” refers to a point in time or a time schedule at which user notification information is to be transmitted to or displayed by the user apparatus, including at least real-time timing and delayed timing.

The term “notification expression” refers to linguistic characteristics or style of the user notification information, including at least a direct expression and a mitigated expression that differ in strength, politeness, or explicitness.

In one embodiment, a server executes a computer program that implements the claimed system. The server comprises at least one processor, a memory storing executable instructions and data structures, and a network interface configured to communicate with a plurality of terminals operated by users. The terminals comprise general-purpose computing devices such as smartphones, tablet computers, personal computers, and wearable devices such as smart glasses. Each terminal executes a client application that acquires communication content from a user, transmits the communication content to the server over a packet-based communication network, and displays user notification information received from the server.

The server operates under a general-purpose operating system and executes software components implemented, for example, in a high-level programming language. The server optionally uses existing libraries such as a message broker library, a natural language processing library, and a deep learning framework, including libraries comparable to message queuing middleware, general-purpose NLP toolkits (for example, tokenization and part-of-speech tagging libraries), and transformer model frameworks. These components are used not merely as generic tools, but as part of a specifically configured architecture that constructs prompt sentences, invokes a generative AI model, and adjusts notification timing and style based on emotion-related state information.

The server stores communication content and intermediate analysis results in structured data records. In one embodiment, the server represents each unit of communication content as a record that includes at least: a user identifier, a timestamp, a communication channel identifier, and a text string representing the user's message. The server additionally stores evaluation information as associated fields, which include a flag indicating whether an inappropriate expression or an abnormal pattern is present, a severity level, and one or more emotion scores. By storing such information in structured form, the server can perform efficient retrieval, aggregation, and scheduling of notification tasks, which reduces unnecessary database scans and improves response time.

The server uses a language processing module to analyze received text. The language processing module runs on the processor and utilizes, for example, a tokenization algorithm that splits the text into tokens using whitespace and punctuation rules, a part-of-speech tagger based on a statistical model, and a syntactic dependency parser. The server further applies a semantic feature extractor that generates vector representations of tokens and sentences using a pre-trained embedding model. The processor compares these representations and tokens against predetermined patterns stored in a rule database. The predetermined patterns include at least templates corresponding to inappropriate expressions, such as offensive or rude phrases, and templates corresponding to abnormal patterns, such as sequences indicative of data leakage or fraudulent requests.

The server does not merely perform keyword matching; instead, the server uses a combination of rule-based filtering and embedding-based similarity. For example, the server calculates cosine similarity between an embedding of a user message and embeddings of stored pattern phrases, and the server considers both exact matches and near-synonymous expressions. Because the server uses these vector-based comparisons, the server can detect semantically similar inappropriate expressions that are not explicitly included in the rule database, thus improving detection recall without a proportional increase in rule complexity.

The server generates evaluation information based on these analyses. The evaluation information includes a classification label (for example, “inappropriate”, “abnormal”, or “normal”), a severity score computed as a weighted function of rule hits and embedding similarity magnitudes, and a rationale code referencing which patterns were triggered. The server stores the evaluation information in association with the communication content, forming a persistent audit trail.

The server constructs a prompt sentence for a generative AI model by combining the communication content with the evaluation information and with task-specific instructions. In one embodiment, the server uses a prompt template store, which holds several template strings corresponding to different tasks such as content classification, explanation generation, rewriting suggestions, and security warning explanation. The server selects a template according to the detected pattern type and the current system state. For example, when the evaluation information indicates that an inappropriate expression is present, the server generates a prompt sentence such as:
“Judge whether the following message is non-delicate or inappropriate. Answer with ‘YES’ or ‘NO’ and give a short reason. Message: ‘this presentation is totally useless’”

When the evaluation information indicates that a rewrite candidate should be generated, the server constructs another prompt sentence such as:
“Rewrite the following sentence in a polite and positive way suitable for customer service: ‘this product might not look good on you.’”

When an abnormal pattern related to a possible phishing message is detected, the server constructs a prompt sentence such as:
“Explain in simple terms why the following email may be a phishing attempt and recommend safe actions for the user: ‘please click this link and enter your password to keep your account active.’”

The server then inputs the constructed prompt sentence to a generative AI model. In one embodiment, the generative AI model is realized as a transformer-based neural network comprising an encoder-decoder architecture or a decoder-only architecture with multiple self-attention layers, feed-forward layers, and layer normalization. The model parameters include, for example, millions or billions of weight values stored in the server memory. The server executes the model using a deep learning framework that provides tensor operations on a graphics processing unit or a vectorized central processing unit.

The generative AI model has been trained in advance using supervised learning and possibly reinforcement learning from human feedback. During training, the model receives prompt sentences paired with desired responses, and an objective function such as cross-entropy loss is minimized. The training process includes iterative weight updates using stochastic gradient descent or an adaptive variant. The server stores the resulting weight values and uses them for inference in the deployed system. The server does not retrain the model online in the main embodiment, but the server may update the model periodically using new labeled data derived from user feedback.

The generative AI model processes the prompt sentence as a sequence of tokens. The model encodes positional information and uses self-attention computations to capture dependencies between words in the prompt sentence, including the instructions and the user message. Because the prompt sentence explicitly separates instructions from the message content, the model can condition its behavior on the requested task type (for example, classification, explanation, rewriting) without switching to a different model. This explicit prompt structure allows the server to use a single model instance to perform multiple tasks, which reduces memory usage and simplifies deployment compared to systems that require multiple unitary models.

The server parses the response information produced by the generative AI model. In one embodiment, the response information is plain text that includes a classification answer, an explanation, or one or more candidate rewrites. The server applies a post-processing module that uses pattern matching to extract structured fields from the response information, such as a “YES” or “NO” classification, a short justification sentence, or a list of candidate expressions. This module is configured to reject outputs that contain new inappropriate expressions or that do not conform to minimal safety criteria, and to discard or regenerate such outputs if necessary. By performing such post-processing, the server ensures that only compliant, safe content is transmitted to the terminals.

The server further generates user notification information on the basis of the response information. The user notification information includes warning information and, if applicable, expression candidate information. For example, when the generative AI model returns an explanation that a phrase is harsh or insulting, the server assembles a notification such as:
“Your comment might sound very harsh. Please consider giving more specific and constructive feedback instead.”

When the generative AI model returns a rewrite candidate for a customer service context, the server may include both the original and the suggested expression:
“Original: ‘this product might not look good on you.’ Suggested: ‘This product is nice, but I think this other item may suit you even better.’”

In addition to content analysis, the server uses emotional state information to control notification timing and notification expression. The terminal or an auxiliary device, such as a wearable sensor, obtains physiological signals such as heart rate, voice tonality, or facial expressions, and transmits corresponding measurements to the server. The server also analyzes previous communication content using an emotion analysis module that computes sentiment scores based on lexicon features and sentiment-aware embeddings. The emotion analysis module may be implemented as a neural network trained to predict emotion classes (for example, anger, joy, sadness, calmness) based on text and sensor features.

The server fuses these emotion indicators to produce emotional state information. The server, for example, computes a weighted average of emotion scores from text analysis and sensor analysis, and stores a compact representation such as a vector of emotion probabilities. The server then uses this emotional state information to adjust the scheduling and tone of notifications. When the emotional state information indicates a calm or positive state, the server configures the notification to be sent in real time and with a direct expression. When the emotional state information indicates a stressed or negative state, the server delays the notification until the end of a conversation segment or another suitable time, and rewrites the notification text using a more mitigated tone by invoking the generative AI model with an additional prompt sentence such as:
“The user is currently stressed. Rewrite the following feedback in a gentle and supportive manner: ‘Your message contains harsh language that may hurt others.’”

The server thereby achieves a technical improvement in the notification subsystem: unnecessary immediate notifications are suppressed when they are likely to be counterproductive, and the tone of the notification is automatically adapted without requiring separate rule sets for every possible emotional state.

The terminal receives the user notification information over the communication network and displays it in a user interface. When the terminal is a smartphone, the terminal may show a pop-up dialog or an inline banner above the text input area. When the terminal is a wearable device such as smart glasses, the terminal renders the notification as a small overlay in the user's field of view, so that the user can quickly adjust spoken phrases during a conversation. The user may select options to accept a suggested rewrite, to edit the message manually, or to ignore the suggestion. The terminal transmits the user's selection and feedback to the server, which stores this information as additional training data for model improvement.

This architecture yields several technical effects beyond mere automation of human review. First, the explicit introduction of a prompt sentence layer and its systematic construction based on evaluation information allows the server to dynamically reconfigure the generative AI model's inference tasks without switching models or changing code paths. This reduces model-loading overhead, minimizes memory footprint, and improves the throughput of the server's inference pipeline. Second, the combination of rule-based pattern detection, embedding-based similarity quantification, and transformer-based generative inference results in higher detection accuracy for inappropriate expressions and abnormal patterns than rule-based systems alone, while keeping false positive rates manageable by means of the evaluation information and the post-processing module.

Third, the use of emotional state information to control notification timing and notification expression reduces the number of notifications that are generated and transmitted when they are unlikely to be effective, which in turn reduces network traffic and avoids unnecessary rendering operations on terminals. By aligning notification events with user receptiveness, the server reduces wasted computational cycles on both server and terminal, improving overall system efficiency.

Fourth, the ability of the server to generate detailed, context-aware explanations and candidate rewrites relieves client devices and human administrators from maintaining large, static libraries of canned responses. The server effectively decentralizes response generation into the generative AI model and the prompt sentence logic. Because the server can update the model and prompt templates centrally, the server can adapt to new abusive patterns or security threats without redeploying client software, thereby improving maintainability and security responsiveness.

In alternative embodiments, the server may use different model architectures. For example, the server may employ an encoder-only transformer for classification tasks and a decoder-only transformer for explanation and rewriting tasks. The server may share a common embedding layer between these models to reduce memory usage. In another embodiment, the server may use a convolutional neural network or a recurrent neural network with attention to perform emotion classification, while still using a transformer-based generative model for prompt-based text generation. The server may also vary the training strategy, for example, by applying curriculum learning for inappropriate expression detection and fine-tuning on domain-specific corpora for particular communication platforms.

The terminal may also vary in form factor and capabilities. In one embodiment, the terminal is a voice-only device such as a smart speaker, and the terminal uses cloud-based speech recognition to convert audio to text before transmission to the server. In another embodiment, the terminal incorporates local pre-processing, such as keyword masking or on-device sentiment detection, to reduce the data volume and protect user privacy. In each case, the core functions of the server—pattern comparison, prompt sentence construction, generative model inference, emotion-aware notification control, and structured storage of evaluation information—remain as described and support the technical improvements specified in the claims.

Through these embodiments, the server, the terminal, and the user cooperate in a way that implements a concrete technical solution: the system processes structured and unstructured data using specific data structures and model architectures, constructs and uses prompt sentences as controllable interfaces to a generative AI model, and uses emotion-sensitive scheduling to control communication over a network. This configuration improves the functioning of the computer system itself by enhancing detection accuracy, reducing computational overhead, optimizing network usage, and enabling flexible, multi-role use of a single generative AI model in a way that conventional static rule engines and monolithic classifiers cannot achieve.

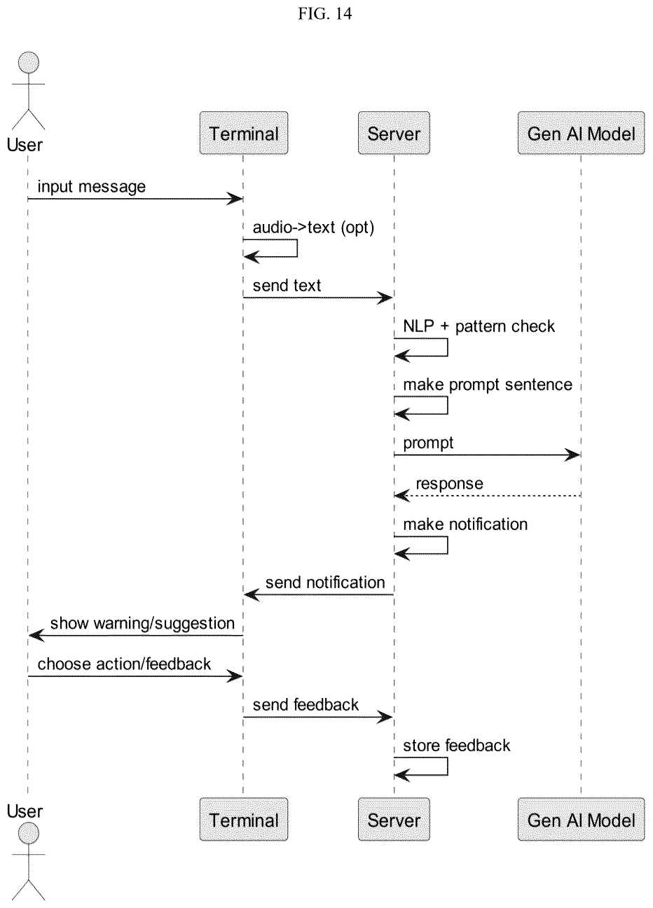

The following describes the processing flow using FIG. 14.

### Step 1

The user inputs communication content on the terminal.
The terminal presents a text input field or a voice input control to the user. The user types a message or speaks into a microphone, for example “this presentation is totally useless”.
Input: user keystrokes or audio waveform.
Output: a raw message object including at least a user identifier, a timestamp, and either a text string or audio data.
The terminal converts the physical user input into a digital representation (text buffer or audio buffer) and stores it temporarily in local memory.

### Step 2

The terminal converts audio to text when necessary.
When the raw message object contains audio data, the terminal sends the audio to a speech recognition component and receives recognized text such as “this presentation is totally useless”.
Input: audio waveform data and associated metadata.
Output: a text string and an updated message object where the audio field is replaced or complemented by a text field.
The terminal applies feature extraction to the audio (for example, framing and spectral analysis) and uses a recognition model to map acoustic features to character sequences, then attaches the recognized string to the message object.

### Step 3

The terminal transmits normalized communication content to the server.
The terminal wraps the text string, user identifier, and timestamp into a normalized data structure and sends it via a network protocol such as HTTPS or a persistent socket connection.
Input: the normalized message object stored in terminal memory.
Output: a network request or message packet delivered to the server.
The terminal performs serialization of the message object, handles retries on communication failures, and records a transmission status.

### Step 4

The server ingests the communication content from the terminal.
The server receives the network request and reconstructs the message object in server memory. The server may enqueue the message in a message queue for further processing.
Input: the serialized message packet received over the communication network.
Output: an internal message record containing user identifier, timestamp, channel identifier, and text string.
The server deserializes the packet, validates required fields, assigns a server-side message identifier, and stores the record in a short-term buffer or database table.

### Step 5

The server applies language preprocessing to the communication content.
The server normalizes the text by lowercasing, removing extraneous whitespace, and optionally masking sensitive tokens. The server then tokenizes and tags parts of speech.
Input: the internal message record including the text string.
Output: a processed text representation including token list, part-of-speech tags, sentence boundaries, and possibly a dependency parse tree.
The server uses a language processing module to run tokenization and tagging algorithms, constructing structured linguistic data that will be used for pattern comparison.

### Step 6

The server compares the processed text with predetermined patterns.
The server accesses a pattern store containing templates and keyword lists for inappropriate expressions and abnormal patterns. The server checks for rule matches and computes similarity with pattern embeddings.
Input: the processed text representation and the stored pattern definitions.
Output: evaluation information including rule hits, similarity scores, and preliminary pattern labels.
The server executes string matching and vector similarity calculations, aggregates rule match counts and similarity values, and generates intermediate scores indicating the likelihood of inappropriate or abnormal content.

### Step 7

The server determines whether the communication content includes inappropriate expressions or abnormal patterns.
The server evaluates the intermediate scores against thresholds and decision rules to produce final determinations.
Input: evaluation information from pattern comparison, including match counts and similarity scores.
Output: classification flags such as “inappropriate=true/false” and “abnormal=true/false”, and a severity level.
The server applies conditional logic, such as comparing scores to predefined thresholds and combining multiple indicators, to compute severity and classification labels.

### Step 8

The server generates a prompt sentence for a generative AI model.
The server selects a prompt template based on the classification result and the intended task (for example, judgement, explanation, or rewriting). The server inserts the original text and relevant evaluation information into the template.
Input: the original text, the classification flags, the severity level, and a template specification.
Output: a fully constructed prompt sentence string.
The server concatenates instruction text and the user message, for example creating:
“Judge whether the following message is non-delicate or inappropriate. Answer with ‘YES’ or ‘NO’and give a short reason. Message: ‘this presentation is totally useless’”.
The server stores this prompt sentence together with the message identifier.

### Step 9

The server inputs the prompt sentence to the generative AI model and obtains response information.
The server encodes the prompt sentence into tokens and feeds them into a generative AI model implemented as a neural network. The server then performs an inference pass and decodes the generated output tokens into text.
Input: the prompt sentence and model parameters stored in server memory.
Output: response information in text form, such as a judgement (“YES”) and a short explanation, or a candidate rewrite.
The server executes attention and feed-forward computations layer by layer in the model, computes probability distributions over output tokens, selects tokens based on these probabilities, and assembles the resulting text sequence as the model's response.

### Step 10

The server parses and structures the response information from the generative AI model.
The server analyzes the textual response to extract structured elements such as classification answers, explanations, and candidate expressions.
Input: the raw response text from the generative AI model.
Output: structured response fields including a decision value, explanatory text, and a list of expression candidates if present.
The server applies pattern matching or simple parsing rules, for example detecting “YES” or “NO” at the beginning of the response, splitting explanation sentences, and identifying quoted candidate expressions.

### Step 11

The server acquires and updates emotional state information for the user.
The server receives emotion-related data from an emotion estimation apparatus or an emotion analysis module, such as sentiment scores from recent messages or physiological indicators from a terminal.
Input: prior emotion records, current communication content, and any sensor measurements from the terminal or external devices.
Output: updated emotional state information, represented as one or more emotion scores or categories.
The server processes text-based features through an emotion classification model, aggregates the outputs with sensor-based features, and computes a consolidated set of emotion probabilities or levels (for example, anger, stress, calmness).

### Step 12

The server determines notification timing and notification expression based on evaluation and emotional state.
The server reads the user's notification preferences and consults the classification flags, severity level, and emotional state information to choose when and how to notify.
Input: classification flags and severity, emotional state information, and user notification settings.
Output: a scheduling decision (for example, immediate or delayed) and a style decision (for example, direct or mitigated notification wording).
The server executes decision rules such as “if severity is high and emotion is calm, notify immediately with direct tone” or “if severity is high and emotion is stressed, delay notification and use mitigated tone”, and stores the resulting decisions in a scheduling queue.

### Step 13

The server generates user notification information including warning and expression candidate information.
The server composes a notification message that may include a warning description and any expression candidates. The server may call the generative AI model again with a dedicated prompt sentence to adjust the tone of the notification.
Input: structured response fields, scheduling and style decisions, and optionally an additional tone-adjustment prompt sentence.
Output: a user notification object containing notification text, optional suggested expressions, and metadata for delivery.
The server merges the explanation and candidate rewrites into a coherent notification, for example: “Your comment might sound very harsh. Please consider giving more specific and constructive feedback instead.”
If tone adjustment is required, the server constructs a prompt sentence such as “The user is currently stressed. Rewrite the following feedback in a gentle and supportive manner: ‘Your message contains harsh language that may hurt others.’” and uses the result as the final notification text.

### Step 14

The server transmits the user notification information to the terminal in accordance with the scheduling decision.
The server enqueues or directly sends the notification object through a communication channel to the terminal.
Input: the user notification object and scheduling information.
Output: a notification message delivered to the terminal at the determined time.
The server formats the notification for transport, selects an appropriate protocol (for example, push notification, WebSocket message, or HTTP response), and logs delivery attempts and outcomes.

### Step 15

The terminal receives and displays the user notification information.
The terminal listens for incoming notification messages from the server and, upon receipt, converts the notification text and candidate expressions into visual or audio output for the user.
Input: the notification message from the server.
Output: a rendered notification on the terminal's display or audio output, such as a pop-up warning and suggested rewrite.
The terminal parses the notification object, selects a UI component (dialog, banner, overlay), and presents options such as “Use suggested text”, “Edit manually”, or “Ignore”.

### Step 16

The user responds to the notification and optionally provides feedback.
The user reviews the warning and any suggested expressions and selects an available option, for example adopting the suggested text or editing the message. The user may also indicate whether the notification was helpful or correct.
Input: the displayed notification and UI controls.
Output: user actions such as text selection, message editing, or feedback flags.
The user manipulates the terminal interface, and the terminal records the selected option and any feedback for transmission to the server.

### Step 17

The terminal sends user actions and feedback back to the server.
The terminal packages the user's selection, any modified message content, and feedback labels into a data structure and transmits it to the server.
Input: internal records of user actions and feedback on the terminal.
Output: a feedback message delivered to the server.
The terminal serializes the data, sends it over the communication network, and waits for an acknowledgment.

### Step 18

The server stores feedback and optionally updates model-related data.
The server receives the feedback message and associates it with the corresponding message and notification records. The server adds the feedback to a dataset for later analysis or model fine-tuning.
Input: the feedback message including user selection and correctness indication.
Output: updated storage records linking original communication content, system decisions, and user feedback.
The server writes these records to persistent storage, computes summary statistics such as accuracy of notifications, and may schedule offline processes that use this data to adjust thresholds, refine pattern sets, or retrain the generative AI model and associated classifiers.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

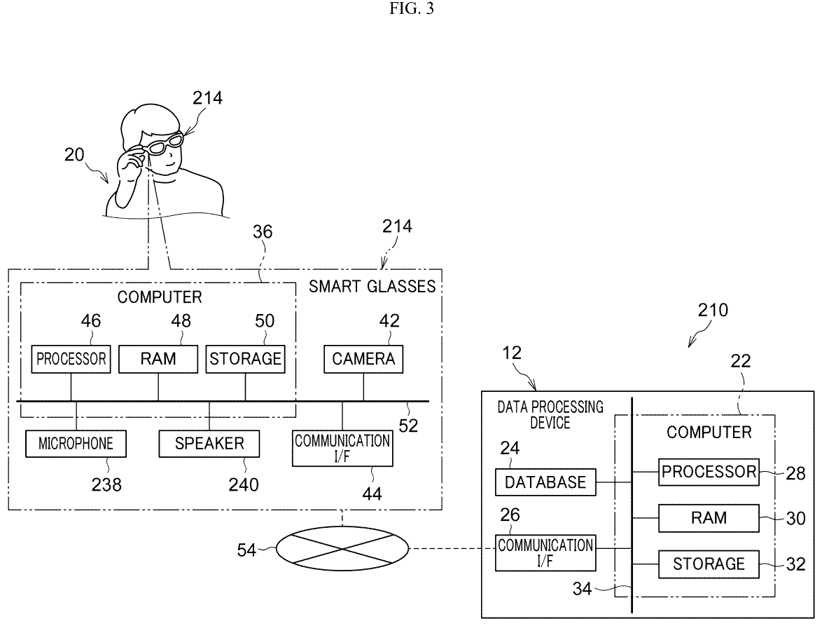

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

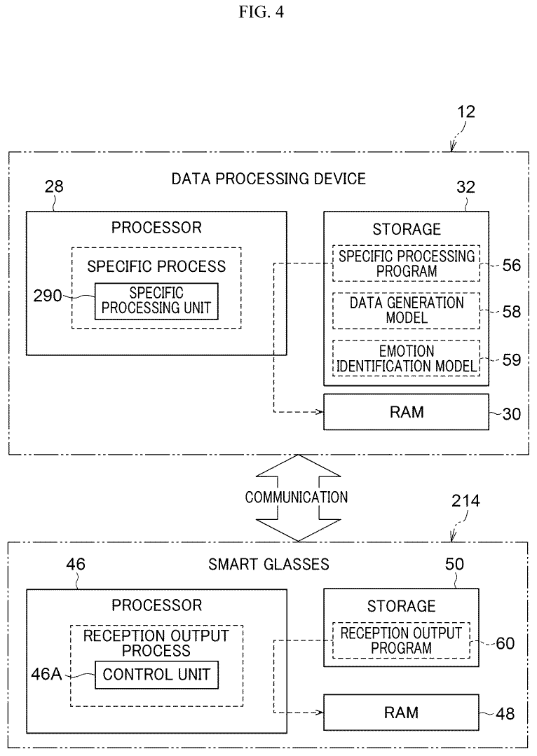

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

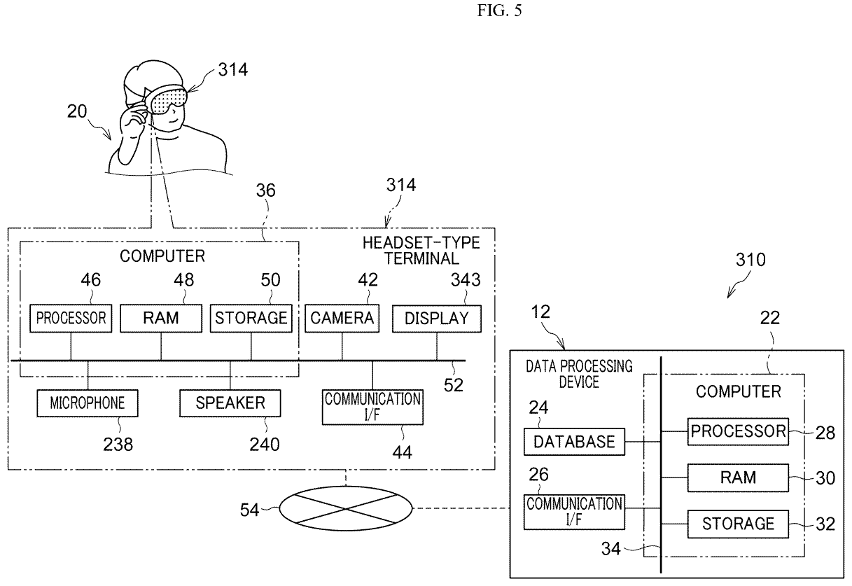

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

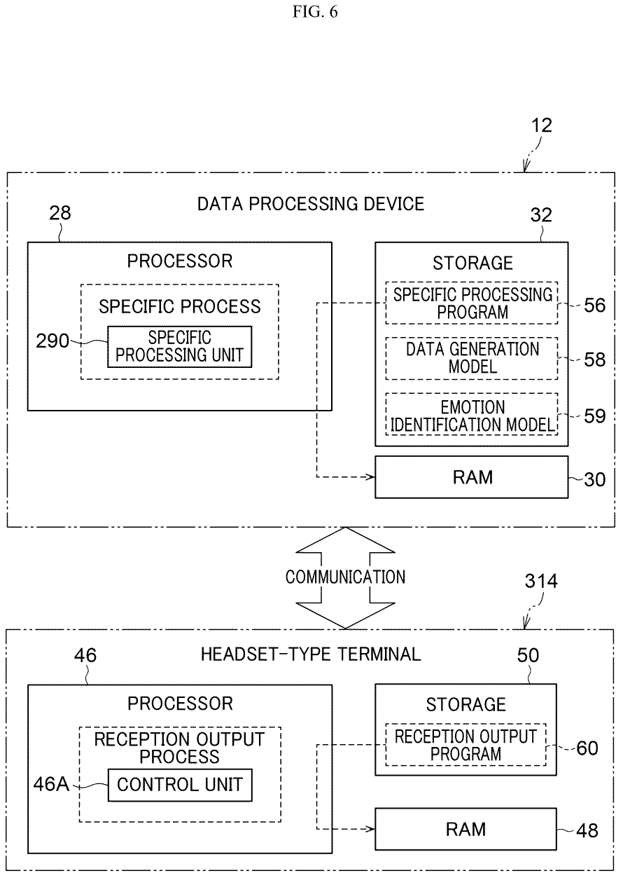

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

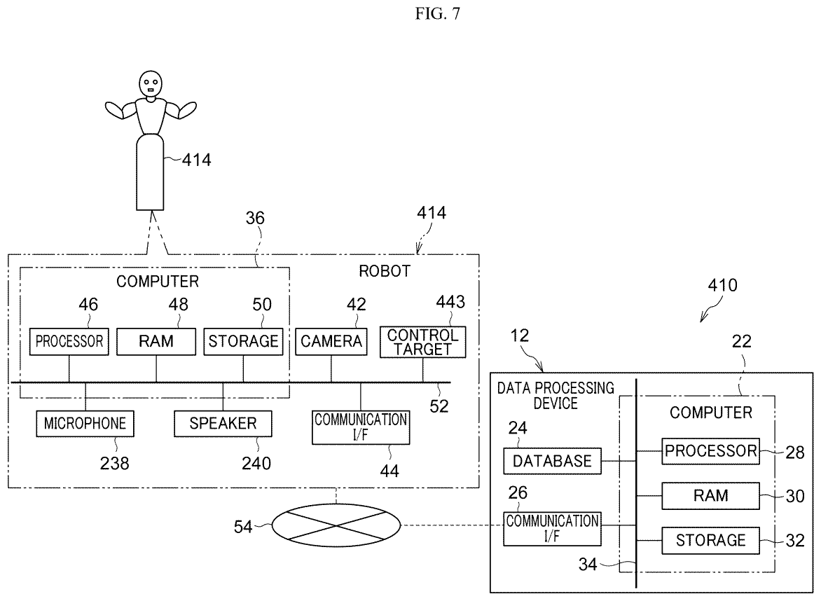

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

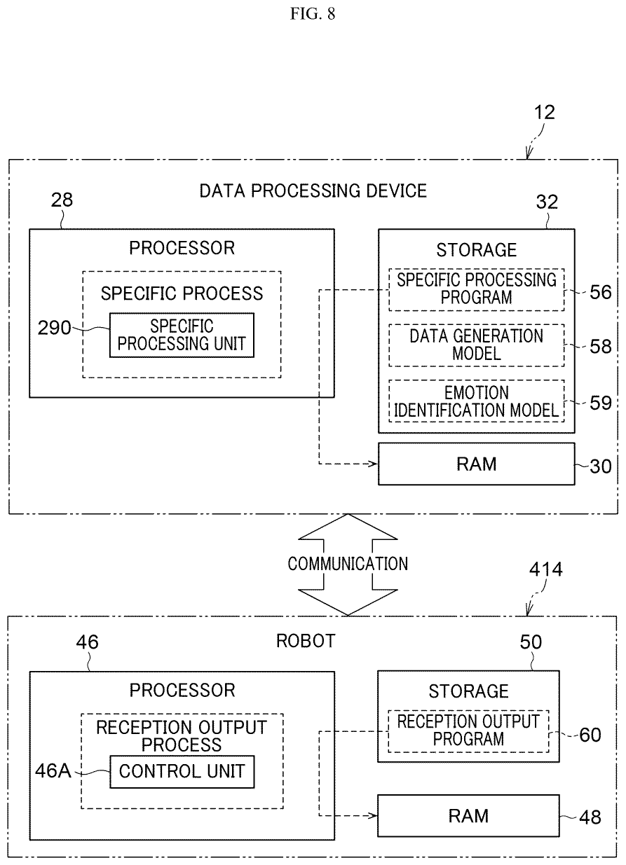

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

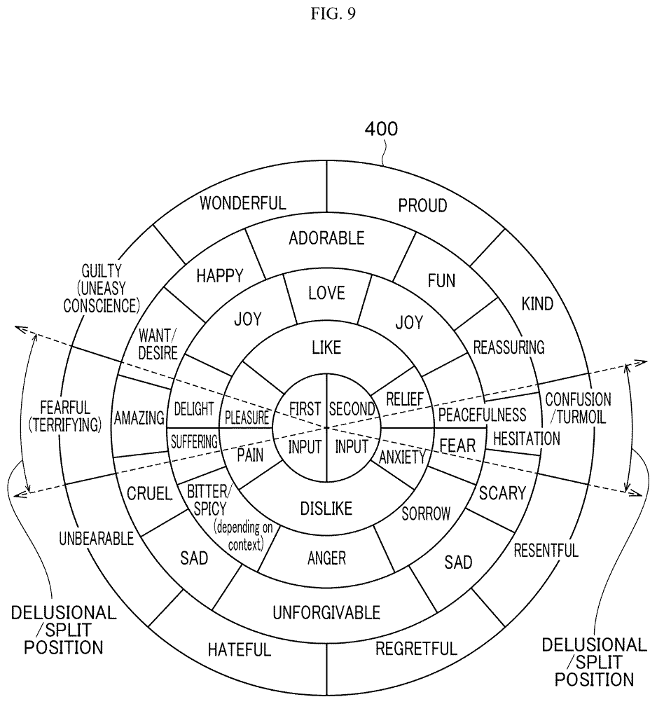

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

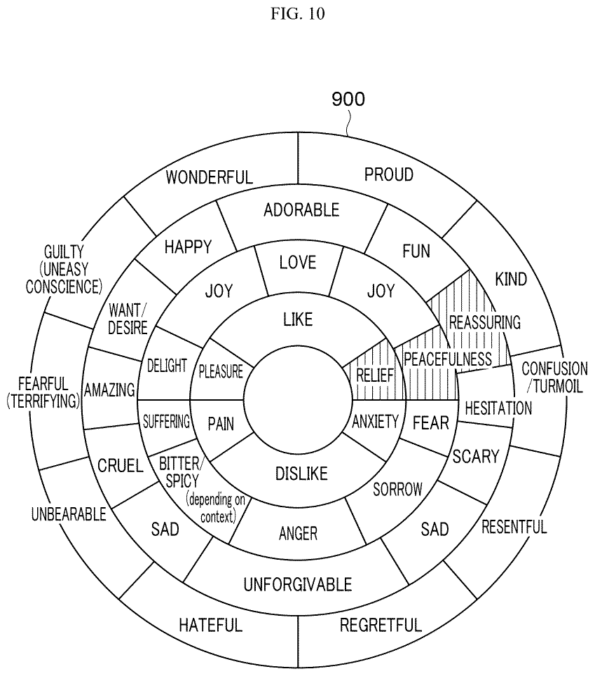

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
acquire, on a user terminal, communication information of a user including electronic communication information and voice communication information, and transmit the communication information via a communication network,
convert voice communication information received from the user terminal into character information by using a speech recognition processing service, and generate text information from the character information,
integrate the text information received from the user terminal, and structure the integrated text information as analysis target information to which additional information including a communication type, time information, user identification information, and language type is attached,
select, based on the analysis target information, analysis rules including analysis items, output formats, importance determination conditions, and model operation conditions, generate a natural language analysis instruction sentence according to the analysis rules, and generate a prompt sentence in which the analysis target information is embedded within the analysis instruction sentence,
input the prompt sentence to a generative artificial intelligence model and obtain, from the generative artificial intelligence model, analysis result information including important word information, summary information, emotion information, and action item information, parse the analysis result information into a machine-readable format, inspect data formats, value ranges, and item consistency of the analysis result information, and, in response to an abnormality, generate a re-prompt sentence requesting structured output to the generative artificial intelligence model so as to correct the analysis result information,
aggregate and rank corrected analysis result information based on the time information and the importance determination conditions to generate notification candidate information, and transmit, based on the notification candidate information, notification information including the analysis result information to the user terminal in real time or in accordance with user settings.

### Supplementary 2

The system according to supplementary 1,
wherein the processor is configured to
include, in the notification information, the action item information and deadline information extracted from the analysis result information together with priority information, and cause the notification information to be presented as at least one of a screen display, an electronic notification, and a voice guidance.

### Supplementary 3

The system according to supplementary 1,
wherein the processor is configured to
update the analysis rules and generation conditions of the notification candidate information based on setting information acquired from the user and operation history information of the user with respect to the analysis result information.

### Application Example 1

### Supplementary 1

A system comprising a processor,
wherein the processor is configured to
receive, from a communication endpoint device via a communication path, communication content data of multiple types and normalize the communication content data into an internal format including a text representation and associated information,
analyze, using a natural language processing technique, the text representation included in the normalized communication content data by performing at least morphological analysis, syntactic analysis, phrase extraction, feature value calculation, and comparison with a predefined abnormal pattern, and determine whether the communication content data includes a security threat,
when the communication content data includes audio information, convert the audio information into the text representation by an automatic speech recognition function and add the text representation as an additional target of the analysis and abnormal pattern determination using the natural language processing technique,
generate context information including a detection result of the abnormal pattern, identification information extracted from the communication content data, reference information, and a risk index, and provide the context information as input data to a generative artificial intelligence model,
cause the generative artificial intelligence model to generate, based on the context information, a prompt sentence including at least warning content, recommended actions, and confirmation items to be presented to a user, and select, from a generated result, a warning prompt sentence that satisfies a predetermined length, expression style, and risk level, transmit the selected warning prompt sentence as notification information to the communication endpoint device and cause the warning prompt sentence to be displayed to the user on the communication endpoint device, and
acquire, from the communication endpoint device, operation information and evaluation information of the user with respect to the notification information, and update an abnormal pattern determination process and a context information generation process for the generative artificial intelligence model based on the evaluation information.

### Supplementary 2

The system according to supplementary 1,
wherein the processor is configured to
transmit the warning prompt sentence as the notification information within a predetermined delay time from reception of the communication content data so that the warning prompt sentence is presented to the user with substantial real-time performance.

### Supplementary 3

The system according to supplementary 1,
wherein the processor is configured to
control a transmission time or a transmission frequency of the notification information based on display condition information acquired from the user, and adjust presentation of the warning prompt sentence so that the warning prompt sentence is presented in accordance with a time period or a priority specified by the user.

### Example 2

### Supplementary 1

A system comprising a processor,
wherein the processor is configured to
acquire communication content from a user terminal through a communication network and store the communication content as text information,
perform natural language processing on the text information, the natural language processing including word segmentation processing and part-of-speech tagging processing, and, based on an analysis result of the natural language processing, identify expressions that are insulting or inappropriate by comparing tokens in the text information with a predefined judgment vocabulary set, and generate analysis result data including attribute information relating to the identified inappropriate expressions,
generate a prompt sentence, based on the analysis result data and the text information, for input to a generative AI model, input the prompt sentence into the generative AI model, and obtain response information including at least one of (i) content and reasons regarding the inappropriate expressions and (ii) alternative expression candidates,
generate notification information including at least the text information containing the inappropriate expressions, explanation information corresponding to the inappropriate expressions, and the alternative expression candidates, based on the analysis result data and the response information, and transmit the notification information to the user terminal, and control at least one of presence or absence of transmission of the notification information and conditions of transmission of the notification information, based on user setting information.

### Supplementary 2

The system according to supplementary 1,
wherein the processor is configured to
provide the notification information as warning information that is transmitted to the user terminal in real time immediately after detection of the inappropriate expressions.

### Supplementary 3

The system according to supplementary 1,
wherein the processor is configured to
refer to the user setting information including at least one of a transmission time of the notification information, a transmission frequency of the notification information, and a threshold of severity for the inappropriate expressions, and adjust at least one of a transmission timing and a transmission target of the notification information in accordance with the user setting information.

### Application Example 2

### Supplementary 1

A system comprising a processor,
wherein the processor is configured to
acquire communication content from a user apparatus via a communication network, analyze the acquired communication content using a language processing technique and compare the analyzed communication content with predetermined patterns including at least an inappropriate expression and an abnormal pattern so as to generate evaluation information of the communication content,
determine, on the basis of the evaluation information, whether the communication content includes the inappropriate expression or the abnormal pattern, generate a prompt sentence, on the basis of the communication content and the evaluation information, for input to a generative AI model,
input the prompt sentence to the generative AI model and obtain, from the generative AI model, response information including a content of the inappropriate expression or the abnormal pattern and a recommended response for a user,
generate user notification information including warning information or expression candidate information, on the basis of the response information,
adjust a notification timing or a notification expression of the user notification information, on the basis of emotional state information acquired from an emotion estimation apparatus or an emotion analysis module, and
transmit the user notification information to the user apparatus.

### Supplementary 2

The system according to supplementary 1,
wherein the processor is configured to
select the notification timing of the user notification information as real-time notification or delayed notification, and select the notification expression as a direct expression or a mitigated expression, on the basis of the emotional state information and the evaluation information.

### Supplementary 3

The system according to supplementary 1,
wherein the processor is configured to
include, in the prompt sentence, an instruction sentence that instructs the generative AI model to generate the expression candidate information for rewriting the communication content into an expression that is not an inappropriate expression, and to obtain, as the response information, the expression candidate information generated by the generative AI model.

What is claimed is:

1. A system comprising:
circuitry configured to:
receive, via a communication interface coupled to a packet-switched network, communication information comprising electronic communication information and voice communication information from a terminal device, convert the voice communication information into character information using a speech recognition processing service, and generate text information from the character information;
integrate the text information with additional information comprising a communication type, time information, user identification information, and language type to generate structured analysis target information stored in a storage device;
select, based on the analysis target information, analysis rules comprising analysis items, output formats, importance determination conditions, and model operation conditions, and generate a prompt sentence in which the analysis target information is embedded within a natural language analysis instruction sentence constructed according to the analysis rules, and transmit the prompt sentence to a generative neural network model via the communication interface to obtain analysis result information comprising summary information, and action item information;
parse the analysis result information into a machine-readable format, inspect data formats, value ranges, and item consistency of the analysis result information, and, in response to a detected inconsistency, generate a re-prompt sentence requesting structured output and transmit the re-prompt sentence to the generative neural network model to obtain corrected analysis result information;
aggregate and rank the corrected analysis result information based on the time information and the importance determination conditions to generate notification candidate information; and
transmit, based on the notification candidate information, notification information comprising the corrected analysis result information to the terminal device via the communication interface in real time or in accordance with user settings stored in the storage device.

2. The system according to claim 1, wherein the circuitry is configured to include, in the notification information, action item information and deadline information extracted from the corrected analysis result information together with priority information, and to cause the notification information to be presented as at least one of a screen display, an electronic notification, and a voice guidance.

3. The system according to claim 2, wherein the circuitry is configured to apply a scheduling function to the deadline information and the priority information to generate a ranked action sequence, and to transmit the ranked action sequence to the terminal device in a structured format enabling calendar integration.

4. The system according to claim 2, wherein the circuitry is configured to update the priority information based on feedback data received from the terminal device indicating whether the user completed or deferred an action item, and to store the updated priority information in the storage device for use in subsequent aggregation and ranking operations.

5. The system according to claim 1, wherein the circuitry is configured to update the analysis rules and generation conditions of the notification candidate information based on setting information received from the terminal device and operation history information of the user stored in the storage device.

6. The system according to claim 5, wherein the circuitry is configured to apply a rule optimization function to the operation history information to identify analysis rules that have a high correlation with user-accepted notification candidate information, and to assign higher selection weights to those rules in subsequent analysis rule selection operations.

7. The system according to claim 5, wherein the circuitry is configured to generate a plurality of prompt sentence variants based on alternative analysis rule configurations, evaluate the resulting analysis result information from the generative neural network model against a quality scoring function, and select the analysis rule configuration that produces the highest quality score for subsequent processing cycles.

8. The system according to claim 1, wherein the circuitry is configured to apply a de-identification function to the analysis target information prior to transmitting the prompt sentence to the generative neural network model, replacing the user identification information and other personally identifiable elements with anonymized tokens, and to restore the original identifiers in the notification information using a mapping table stored in the storage device.

9. The system according to claim 8, wherein the circuitry is configured to store the mapping table in an encrypted format in the storage device, and to apply a key management protocol to control access to the mapping table based on user authorization levels stored in the storage device.

10. The system according to claim 1, wherein the circuitry is configured to apply a language detection function to the character information, and to generate the prompt sentence in a target language different from a source language of the character information when the detected language does not match a preferred language stored in the storage device for the user identification information.

11. The system according to claim 10, wherein the circuitry is configured to apply a back-translation validation function to the corrected analysis result information by translating the corrected analysis result information back to the source language and comparing it against the original character information to detect semantic inconsistencies, and to generate an additional re-prompt sentence when semantic inconsistencies are detected.

12. The system according to claim 1, wherein the circuitry is configured to limit the number of re-prompt sentence regeneration cycles to a maximum threshold stored in the storage device, and to transmit partial notification information comprising only successfully parsed and validated portions of the analysis result information to the terminal device when the maximum threshold is reached.

13. The system according to claim 12, wherein the circuitry is configured to log each re-prompt sentence cycle, the associated inconsistency type, and the corrected analysis result information in the storage device as quality management records, and to provide the quality management records to an administrative terminal device upon request via the communication interface.

14. The system according to claim 1, wherein the circuitry is configured to apply a speech recognition confidence scoring function to the character information generated from the voice communication information, and to apply a secondary speech recognition processing service to portions of the voice communication information for which the confidence score falls below a threshold prior to integrating the text information.

15. The system according to claim 14, wherein the circuitry is configured to flag portions of the analysis target information derived from low-confidence character information in the structured analysis target information, and to include confidence indicators in the notification information transmitted to the terminal device.

16. The system according to claim 1, wherein the circuitry is configured to apply a classification function to the corrected analysis result information to assign a category label and an importance score to each item of notification candidate information, and to filter the notification candidate information by excluding items whose importance score falls below a user-configurable threshold stored in the storage device.

17. The system according to claim 16, wherein the circuitry is configured to receive a threshold adjustment instruction from the terminal device via the communication interface, update the user-configurable threshold in the storage device, and reprocess the notification candidate information using the updated threshold without re-querying the generative neural network model.

18. A system comprising:
circuitry configured to:
receive, via a communication interface coupled to a packet-switched network, electronic communication information and voice communication information from a terminal device, convert the voice communication information into character information using a speech recognition processing service, and integrate the character information with additional information comprising a communication type, time information, and user identification information to generate structured analysis target information stored in a storage device;
select analysis rules comprising analysis items, output formats, and importance determination conditions based on the analysis target information, embed the analysis target information within a natural language analysis instruction sentence to generate a prompt sentence, and transmit the prompt sentence to a generative neural network model via the communication interface to obtain analysis result information;
parse the analysis result information into a machine-readable format, inspect data formats and item consistency, generate a re-prompt sentence requesting structured output when a format inconsistency is detected, and transmit the re-prompt sentence to the generative neural network model to obtain corrected analysis result information; and
aggregate and rank the corrected analysis result information based on the time information and the importance determination conditions to generate notification candidate information, and transmit notification information comprising the corrected analysis result information to the terminal device via the communication interface in real time or in accordance with user settings stored in the storage device.

19. The system according to claim 18, wherein the circuitry is configured to limit the number of re-prompt sentence regeneration cycles to a maximum threshold, and to transmit partial notification information comprising only successfully validated portions of the analysis result information when the maximum threshold is reached.

20. A method comprising:
receiving, via a communication interface coupled to a packet-switched network, communication information comprising electronic communication information and voice communication information from a terminal device, converting the voice communication information into character information using a speech recognition processing service, and generating text information from the character information;
integrating the text information with additional information comprising a communication type, time information, user identification information, and language type to generate structured analysis target information;
selecting, based on the analysis target information, analysis rules comprising analysis items, output formats, importance determination conditions, and model operation conditions, and generating a prompt sentence in which the analysis target information is embedded within a natural language analysis instruction sentence, and transmitting the prompt sentence to a generative neural network model via the communication interface to obtain analysis result information;
parsing the analysis result information into a machine-readable format, inspecting data formats, value ranges, and item consistency, and, in response to a detected inconsistency, generating a re-prompt sentence and transmitting the re-prompt sentence to the generative neural network model to obtain corrected analysis result information;
aggregating and ranking the corrected analysis result information based on the time information and the importance determination conditions to generate notification candidate information; and
transmitting, based on the notification candidate information, notification information comprising the corrected analysis result information to the terminal device via the communication interface in real time or in accordance with user settings.
